(19) United States
(12) Patent Application Publication
(10) Pub. No.: US 2006/0045466 A1
(43) Pub. Date: Mar. 2, 2006

(54) Recording apparatus, recording and playback apparatus, and recording and playback method

(75) Inventors: Teruhiko Sasaki, Chiba (JP); Shuichi Noguchi, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 11/207,022

(22) Filed: Aug. 19, 2005

(30) Foreign Application Priority Data
Sep. 2, 2004 (JP) 2004-255674

(51) Int. Cl. H04N 5/93; G11B 27/00; H04N 5/91

(52) U.S. Cl. 386/52; 386/57; 386/69

(57) ABSTRACT

Video data is recorded onto a disk-like recording medium. An image recorded on the disk-like recording medium is displayed at a high speed without playing back the image.

### CROSS REFERENCES TO RELATED APPLICATIONS

The present invention contains subject matter related to Japanese Patent Application JP 2004-255674 filed in the Japanese Patent Office on Sep. 2, 2004, the entire contents of which are incorporated herein by reference.

### BACKGROUND OF THE INVENTION

1. Field of the Invention

The present invention relates to a recording and playback technique for recording video data onto a disk-like recording medium and displaying the video data, recorded on the disk-like recording medium, at a high speed.

2. Description of the Related Art

Still pictures captured by a digital still camera are typically recorded as an exchangeable image (Exif) file onto a recording medium.

When a thumbnail image corresponding to a still image recorded on the recording medium is displayed on a display of a digital still camera, the digital still camera reads and displays thumbnail data in the Exif file. For example, a technique of displaying a thumbnail image is disclosed in Japanese Unexamined Patent Application Publication No. 2002-209163.

### SUMMARY OF THE INVENTION

When a plurality of thumbnail images are displayed from a disk-like recording medium, a plurality of Exif files need to be accessed. Threads are moved by several times. After a user command to display a thumbnail image is issued, it takes time for the thumbnail image to be actually displayed on a display screen.

It is thus desirable to display a thumbnail image at a high speed.

In accordance with one embodiment of the present invention, a recording and playback apparatus for recording data onto a disk-like recording medium, includes a unit for acquiring video data and video related data related to the video data, a unit for generating a related data file based on at least one unit of acquired video related data, a unit for generating management information that manages a recording location of the generated related data file recorded on the disk-like recording medium, and a unit for recording the generated related data file and the management information onto the disk-like recording medium.

In accordance with another embodiment of the present invention, a playback apparatus for playing back a video data from a disk-like medium storing a video file containing the video data and video related data related to the video data, includes a unit for playing back data from the recording medium, a unit for extracting specified video related data from a related data file that is played back by the playback means that records at least one unit of video related data, a unit for outputting the video data to a display displaying an image, a unit for inputting an operational command to display the image, and a unit for controlling the playback means to play back the related data file containing at least one unit of related data related to the image responsive to the command and to extract the video related data related to the video data from the playback related data file to display the extracted video related data on the display if the command to display the image is input by the operation input means.

In accordance with yet another embodiment of the present invention, a recording and playback method of recording data onto a disk-like recording medium and playing back data from the disk-like recording medium, includes steps of acquiring video data and video related data related to the video data, generating a related data file based on at least one unit of acquired video related data, recording the generated related data file as data different from the video data onto the disk-like recording medium, and recording, on the disk-like recording medium, management information that manages the video data and the related data file containing the data related to the video data.

### BRIEF DESCRIPTION OF THE DRAWINGS

FIG. 1 is a block diagram of a recording and playback apparatus in accordance with one embodiment of the present invention;

FIG. 2 is a block diagram of a media drive of FIG. 1;

FIG. 3 is a block diagram illustrating the functional structure of the recording and playback apparatus of FIG. 1;

FIG. 4 illustrates a format of Exif file;

FIG. 5 illustrates, in detail, APP1 of FIG. 4;

FIG. 6 illustrates a disk having specifications of the next-generation MD1 system;

FIG. 7 illustrates a recording area of the disk having specifications of the next-generation MD1 system;

FIGS. 8A and 8B illustrate a disk having specifications of the next-generation MD2 system;

FIG. 9 illustrates a recording area of the disk having specifications of the next-generation MD2 system;

FIG. 10 diagrammatically illustrates a format of UID;

FIG. 11 is a flowchart of a video capturing process of the recording and playback apparatus of FIG. 3;

FIG. 12 is a continuation of the flowchart of FIG. 11;

FIG. 13 illustrates a table stored in a table memory of FIG. 3;

FIG. 14 illustrates a thumbnail file;

FIG. 15 illustrates the thumbnail file;

FIG. 16 illustrates a recorded file;

FIG. 17 illustrates information managed in an FAT area;

FIG. 18 illustrates a recorded file;

FIG. 19 illustrates information managed in an FAT area;

FIG. 20 illustrates a thumbnail file;

FIG. 21 illustrates a recorded file;

FIG. 22 illustrates information managed in an FAT area;

FIG. 23 illustrates a thumbnail file;

FIG. 24 is a flowchart illustrating a thumbnail image display process of the recording and playback apparatus of FIG. 3;

FIG. 25 is a flowchart illustrating a main image display process of the recording and playback apparatus of FIG. 3;

FIG. 26 is a flowchart illustrating an Exif file deletion process of the recording and playback apparatus of FIG. 3;

FIG. 27 illustrates a recorded file;

FIG. 28 illustrates a thumbnail file;

FIG. 29 illustrates information managed in an FAT area;

FIG. 30 is a block diagram of a personal computer;

FIG. 31 is a flowchart illustrating an Exif file deletion process of an external apparatus;

FIG. 32 illustrates a recorded file;

FIG. 33 illustrates information managed in an FAT area;

FIG. 34 is a flowchart illustrating an Exif file recording process of the external apparatus;

FIG. 35 illustrates a recorded file;

FIG. 36 illustrates information managed in an FAT area;

FIG. 37 is a flowchart illustrating a reorganization process performed when the external apparatus modifies data;

FIG. 38 is a continuation of the flowchart of FIG. 37;

FIG. 39 illustrates a thumbnail file; and

FIG. 40 illustrates information managed in an FAT area.

### DESCRIPTION OF THE PREFERRED EMBODIMENTS

The embodiments of the present invention are described below with reference to the drawings.

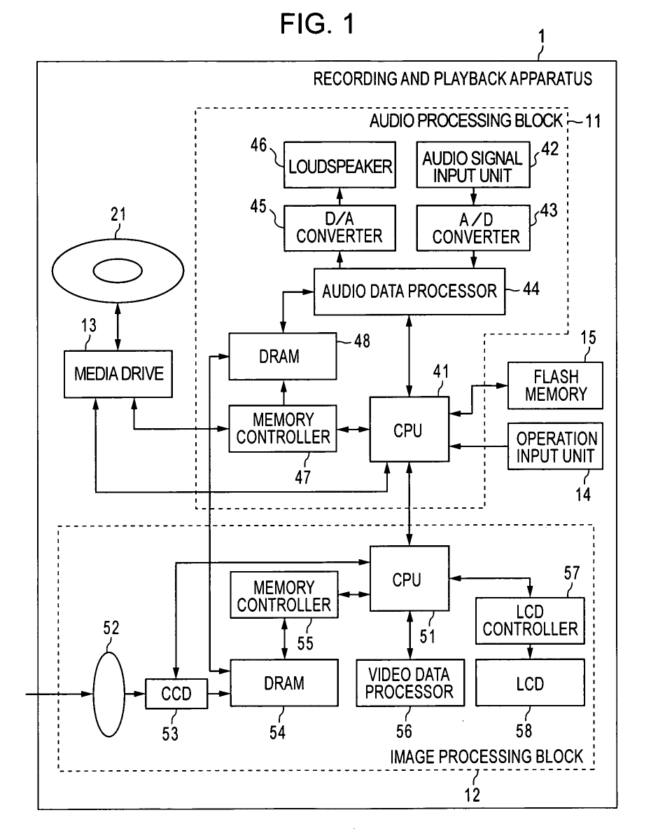

FIG. 1 is a block diagram of a recording and playback apparatus 1 of one embodiment of the present invention. The recording and playback apparatus 1 records data onto a magneto-optic disk 21, and reads data from the magneto-optic disk 21 for playback.

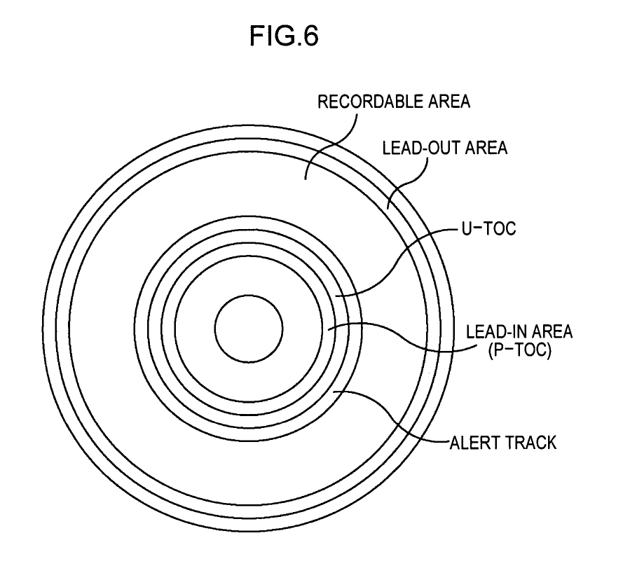

In accordance with this embodiment, the magneto-optic disk 21 is used as a recording medium. To record and play back content data, such as video data and audio data, the recording and playback apparatus 1 uses a file allocation table (FAT) system as a file management system. The recording and playback apparatus 1 of the present embodiment assures compatibility with currently available personal computers. The magneto-optic disk 21 is described later with reference to FIGS. 6 through 10.

The recording and playback apparatus 1 includes an audio processing block 11, an image processing block 12, a media drive 13, an operation input unit 14, and a flash memory 15.

The audio processing block 11 processes information relating to audio. The image processing block 12 processes information relating to video. The media drive 13 records data onto the magneto-optic disk 21, and plays back data recorded on the magneto-optic disk 21. The operation input unit 14 receives an operational input from a user. The flash memory 15 stores, as necessary, data supplied from a central processing unit (CPU) 41 in the audio processing block 11. In accordance with the present embodiment, the media drive 13 is controlled by the audio processing block 11.

The audio processing block 11 includes the CPU 41, an audio signal input unit 42, an analog-to-digital (A/D) converter 43, an audio data processor 44, a digital-to-analog (D/A) converter 45, a loudspeaker 46, a memory controller 47, and a dynamic random access memory (DRAM) 48.

The CPU 41 controls elements in the audio processing block 11, the media drive 13, and a CPU 51 of the image processing block 12. Upon receiving a variety of control information from the audio data processor 44, the CPU 41 controls the elements to perform predetermined processes. In accordance with the present embodiment, the CPU 41 in the audio processing block 11 manages a thumbnail file generated by the image processing block 12 and information in a FAT area read from the magneto-optic disk 21.

Upon receiving an audio signal, the audio signal input unit 42 supplies the A/D converter 43 with the received audio signal (in an analog form). The A/D converter 43 analog-to-digital converts the analog audio signal into a digital audio signal. The A/D converter 43 then supplies the digital audio signal to the audio data processor 44.

The audio data processor 44 performs a variety of processes on the audio data. For example, the audio data processor 44 converts the audio data supplied from the A/D converter 43 in a format to be recorded on the magneto-optic disk 21. The audio data processor 44 decodes the audio data encoded in accordance with a predetermined standard and supplied from the DRAM 48. The audio data processor 44 supplies the D/A converter 45 with the decoded audio data. The D/A converter 45 digital-to-analog converts the digital audio data and supplies the resulting analog signal to the loudspeaker 46. The loudspeaker 46 outputs an audio in response to the input audio signal.

The audio data processor 44 supplies the DRAM 48 with recording data of the data converted in the format for recording to the magneto-optic disk 21. The DRAM 48 under the control of the memory controller 47 stores the audio data supplied from the audio data processor 44. The audio data processor 44 supplies the CPU 41 with a variety of control information of the data converted in the format for recording to the magneto-optic disk 21.

The memory controller 47 controls the exchanging of playback data from the media drive 13 and record data supplied to the media drive 13. Furthermore, the memory controller 47 reads data from the DRAM 48 at a predetermined timing, and supplies the read data to the media drive 13. The memory controller 47 also causes the DRAM 48 to store the data supplied from the audio data processor 44.

The image processing block 12 includes the CPU 51, a lens 52, a charge-coupled device (CCD) 53, a DRAM 54, a memory controller 55, a video data processor 56, an LCD (liquid-crystal display) controller 57, and an LCD 58.

The CPU 51 controls the elements of the image processing block 12. For example, in response to a request from the CPU 41, the CPU 51 controls elements in the image processing block 12 to perform predetermined processes. The CPU 51 under the control of the CPU 41 controls elements in the image processing block 12 to pick up images. More specifically, the CPU 51 under the control of the CPU 41 controls the encoding and decoding of Joint Photographic Experts Group (JPEG) video data, issues a display command to the LCD 58, and controls data transfer of the JPEG data and OSD (on-screen data) data.

The lens 52 picks up an optical image of a subject. More specifically, the lens 52 collects light to focus the entering optical image of the subject on a CCD 53. The CCD 53 is an image pickup device, and converts the optical image coming in through the lens 52 into an electrical signal responsive to a voltage value as a result of photoelectric conversion of each pixel of the CCD 53. The CCD 53 stores the electrical signal as a video signal and then transfers the video signal to the DRAM 54. Under the control of the memory controller 55, the DRAM 54 stores the video signal from the CCD 53. The DRAM 54 under the control of the memory controller 55 reads predetermined data, supplies the read data to the DRAM 48 in the audio processing block 11, and stores data supplied from the DRAM 48 in the audio processing block 11.

The memory controller 55 controls the exchanging of record data to be supplied to the media drive 13 and data supplied from the CCD 53. The memory controller 55 reads data from the DRAM 54 and supplies the read data to the DRAM 48 at a predetermined timing. If a user issues a request to read a predetermined file to the operation input unit 14, the CPU 41 causes the media drive 13 to read management information recorded in an FAT area of the magneto-optic disk 21 (FAT information). The read FAT information is written onto the DRAM 48 under the control of the memory controller 47. Based on the FAT information, the CPU 41 identifies a requested file, and causes the media drive 13 to read data forming the file. To record the file on the magneto-optic disk 21, the CPU 41 supplies the record data to the media drive 13 for recording the record data and updating the FAT information.

The video data processor 56 under the control of the CPU 51 performs a variety of processes on the video data. For example, the video data processor 56 generates an Exif (exchangeable image file) file and a thumbnail file in response to a captured image. The LCD controller 57 under the control of the CPU 51 controls the LCD 58. For example, the LCD controller 57 causes the LCD 58 to display a captured image and/or a thumbnail image. The LCD 58 under the control of the LCD controller 57 displays a variety of images. For example, the LCD 58 displays the captured image and/or the thumbnail image.

As shown in FIG. 1, the two CPU's, namely, the CPU 41 and the CPU 51, are used. Alternatively, a single CPU instead of the two CPU's can be used to handle both video and audio signals. The two memory controllers 47 and 54 and the two DRAM's 48 and 54 are used. Alternatively, a single memory controller can be used instead of the two and a single DRAM can be used instead of the two.

Data exchanging between the CPU 41 and the CPU 51 and between the DRAM 48 and the DRAM 54 is performed using a single serial input/output (SIO) interface. Communications between the CPU 41 and the CPU 51 are performed to perform camera control, and exchange display character information, and commands and data in small size. Communications between the DRAM 48 and the DRAM 54 are performed to exchange JPEG data (Exif file) subsequent to video capturing, display JPEG file, and display OSD data.

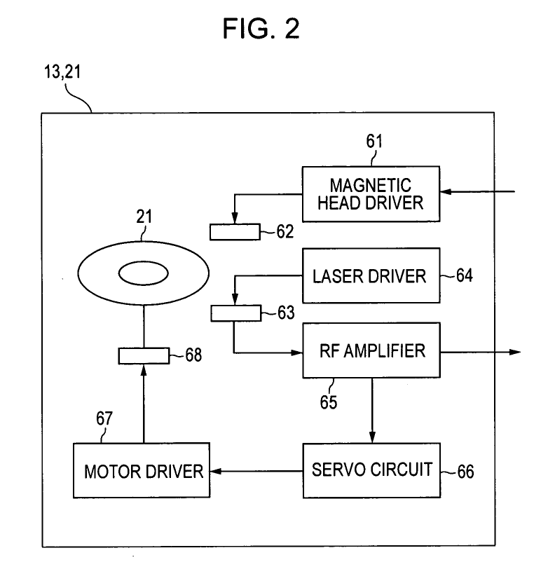

FIG. 2 is a block diagram of the media drive 13 of FIG. 1.

The media drive 13 includes a magnetic head driver 61, a magnetic head 62, an optical head 63, a laser driver 64, an RF amplifier 65, a servo circuit 66, a motor driver 67, and a spindle motor 68.

In the media drive 13, the spindle motor 68 rotates the magneto-optic disk 21 with a turntable attached thereto at a constant linear velocity (CLV). The optical head 63 directs a laser light beam to the magneto-optic disk 21 for recording and playback.

The optical head 63 outputs a relatively high-intensity laser beam to heat a recording track to the Curie temperature during recording, and a relatively low-intensity laser beam to detect data from laser light reflected from the recording track based on the magnetic Kerr effect. The optical head 63 includes an optical system including a laser diode outputting a laser beam, a polarizing beam splitter, and an objective lens, and a detector detecting the reflective light (these elements are not shown). The objective lens in the optical head 63 is movably supported by a two-axis mechanism both in a radial direction of the magneto-optic disk 21 and in a vertical direction toward and away from the surface of the magneto-optic disk 21.

The magnetic head 62 is arranged in a position opposed to the optical head 63 with the magneto-optic disk 21 interposed therebetween. The magnetic head 62 applies to the magneto-optic disk 21 a magnetic field that has been modulated with record data. Also arranged are a sled motor and a sled mechanism (both not shown) to move the entire optical head 63 and the magnetic head 62 in a radial direction across the magneto-optic disk 21.

In the case of the next-generation MD2 disk, the optical head 63 and the magnetic head 62 perform a pulse-driving magnetic modulation to form a tiny mark. In the currently available MD disks and the next-generation MD1 disks, DC light emission magnetic modulation is performed.

The media drive 13 includes a recording processing system, a playback processing system, and a servo system in addition to a recording and playback head system including the optical head 63 and the magnetic head 62, and a disk driving system including the spindle motor 68.

The magneto-optic disk 21 is described later more in detail. The recording and playback apparatus 1 can receive a disk having the current MD specifications, a disk having the next-generation MD1 specifications, and a disk having the next-generation MD2 specifications. The linear velocity is different from disk type to disk type. The spindle motor 68 can rotate a plurality of types of disks different in linear velocity. The magneto-optic disk 21 mounted on the turntable is thus rotated at the linear velocity of each of the disk having the current MD specifications, the disk having the next-generation MD1 specifications, and the disk having the next-generation MD2 specifications.

When the optical head 63 directs the laser light beam to the magneto-optic disk 21, information detected from the reflected laser light (photoelectric current a photodetector detects from the reflected laser light) is supplied to the RF amplifier 65.

The RF amplifier 65 performs current-voltage conversion, amplification, and matrix calculation on the input detected current, thereby resulting in, as playback information, a playback RF signal, a tracking error signal TE, a focus error signal FE, and group information. The RF amplifier 65 feeds the detection information to the CPU 41, the DRAM 48, and the servo circuit 66 as necessary.

In practice, a demodulation process, an error correction process, and a de-interleave process are performed on the detected information supplied from the RF amplifier 65. These processes are not directly related to the present invention and not described herein.

The tracking error signal TE and the focus error signal FE, output from the RF amplifier 65, are supplied to the servo circuit 66. The group information is supplied to the servo circuit 66 for spindle servo control.

The servo circuit 66 generates a spindle error signal for one of constant linear velocity (CLV) servo control and constant angular velocity (CAV) servo control based on an error signal, which is obtained by integrating a phase error of the group information with respect to a playback clock (phase locked loop clock at decoding).

In response to the spindle error signal, and the tracking error signal TE and the focus error signal FE, supplied from the RF amplifier 65, the servo circuit 66 generates a variety of servo signals (including a tracking control signal, a focus control signal, etc.) and outputs the generated signals to the motor driver 67.

The motor driver 67 generates predetermined servo drive signals based on the servo control signal supplied from the servo circuit 66. The servo drive signals include two-axis drive signals for driving the two-axis mechanism (including two types of signals, one in a focus direction and the other in a tracking direction), a sled motor drive signal for driving the sled motor, and a spindle motor drive signal for driving the spindle motor 68. In response to the servo drive signals, the focus control to the magneto-optic disk 21, the tracking control, and one of the CLV servo control and the CAV servo control to the spindle motor 68 are performed.

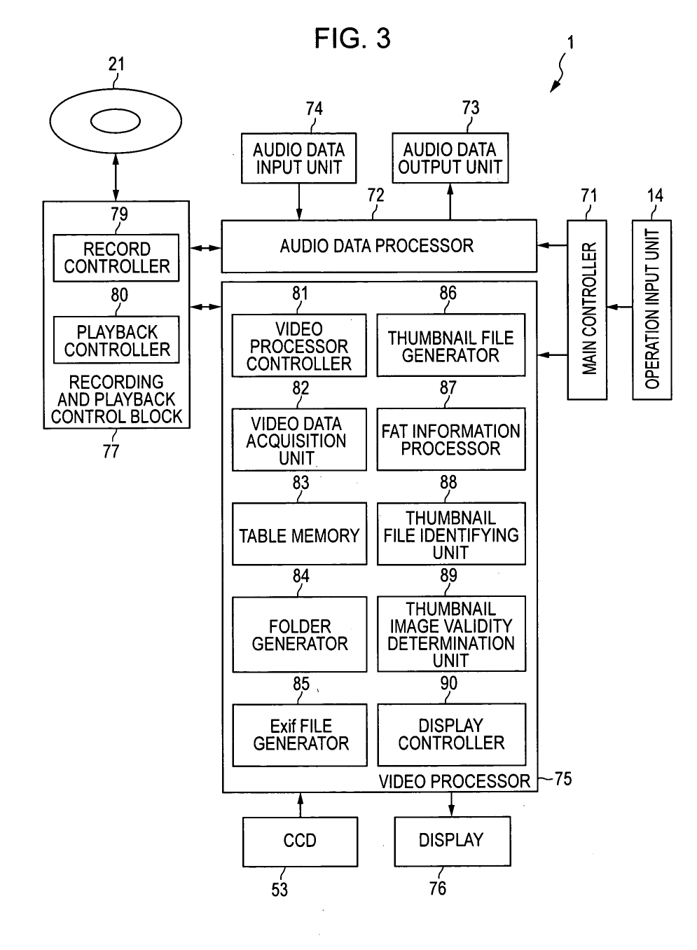

FIG. 3 is a functional block diagram illustrating the recording and playback apparatus 1 of FIG. 1. Elements identical to those described with reference to FIG. 1 are designated with the same reference numerals and the discussion thereof is omitted herein.

The recording and playback apparatus 1 of FIG. 3 further includes a main controller 71, an audio data processor 72, an audio data output unit 73, an audio data input unit 74, a video processor 75, a display 76, a recording and playback control block 77, and further the operation input unit 14, and the magneto-optic disk 21.

The main controller 71 controls the audio data processor 72 and the video processor 75 in response to a control signal responsive to an operational input entered to the operation input unit 14. The main controller 71 is realized by the CPU 41 of FIG. 41. The audio data processor 72 performs a variety of audio processes in response to control signals (commands) from the main controller 71. The audio data processor 72 is realized when the audio data processor 44 and the CPU 41 of FIG. 1 perform predetermined processes. The audio data output unit 73 outputs audio data processed by the audio data processor 72. The audio data output unit 73 is realized when the D/A converter 45 and the loudspeaker 46 perform predetermined processes. The audio data input unit 74 receives audio data, and supplies the audio data to the audio data processor 72. The audio data input unit 74 is realized when the audio signal input unit 42 and the A/D converter 43 of FIG. 1 perform predetermined processes. The main controller 71, the audio data processor 72, the audio data output unit 73 and the audio data input unit 74 illustrated in FIG. 3 show the functions of the audio processing block 11 of FIG. 1.

The video processor 75 performs a variety of image processes in response to control signals (commands) from the main controller 71. The video processor 75 includes a video processor controller 81, a video data acquisition unit 82, a table memory 83, a folder generator 84, an Exif file generator 85, a thumbnail file generator 86, an FAT information processor 87, a thumbnail file identifying unit 88, a thumbnail image validity determination unit 89, and a display controller 90. Within the video processor 75, a variety of data units are exchanged.

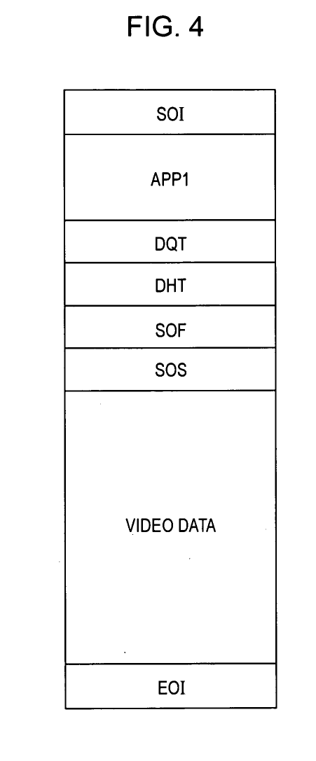

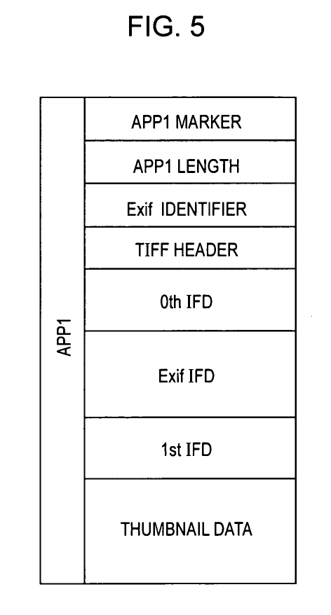

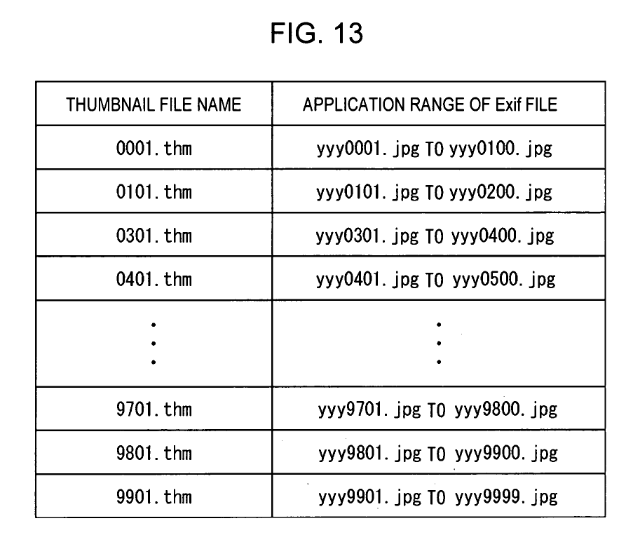

The video processor controller 81 controls internal elements of the video processor 75. The video data acquisition unit 82 acquires video data. More specifically, the video data acquisition unit 82 acquires one of video data input from the CCD 53, an Exif file read from the magneto-optic disk 21, and an Exif file generated by the Exif file generator 85. The video data acquisition unit 82 is realized when the CPU 51, the video data processor 56, and the DRAM 54 of FIG. 1 perform predetermined processes. The table memory 83 stores a table associating the Exif file with the thumbnail file (a table of FIG. 13 to be discussed later). The table memory 83 corresponds to the DRAM 54 of FIG. 1. The folder generator 84 under the control of the video processor controller 81 generates a folder for storing a Exif file and a thumbnail file. The folder generator 84 is realized when one of the CPU 51 and the video data processor 56 of FIG. 1 performs predetermined processes. The Exif file generator 85 generates an Exif file based on the video data. The Exif file generator 85 is realized when the video data processor 56 of FIG. 1 performs predetermined processes. The thumbnail file generator 86 performs processes on the thumbnail file. For example, the thumbnail file generator 86 generates and/or updates a thumbnail file based on the Exif file. The format of the Exif file generated by the thumbnail file generator 86 is described below with reference to FIGS. 4 and 5. The thumbnail file generator 86 is realized when the video data processor 56 of FIG. 1 performs predetermined processes.

The FAT information processor 87 performs predetermined processes on management information indicating the recording location of each file on the magneto-optic disk 21 (information recorded on the FAT area of the magneto-optic disk 21). More specifically, the FAT information processor 87 generates and/or updates the FAT information for managing the recording location of a file on the magneto-optic disk 21. The FAT information processor 87 is realized when the CPU 41 of FIG. 1 performs predetermined processes. The FAT information is used to manage a physical arrangement of clusters forming a file on the magneto-optic disk 21. In an actual FAT file system, a file name and location information of data forming a file corresponding to the file name on the magneto-optic disk 21 are managed by directory entry. A requested file can be read using the FAT information.

The thumbnail file identifying unit 88 identifies a thumbnail file corresponding to an Exif file and identifies an Exif file corresponding to a thumbnail file. For example, the thumbnail file identifying unit 88 identifies a thumbnail file corresponding to an Exif file based on a table stored in the table memory 83. The thumbnail file identifying unit 88 is realized when the CPU 51 and the video data processor 56 of FIG. 1 perform predetermined processes. The thumbnail image validity determination unit 89 determines whether thumbnail video data is valid for the Exif file. For example, the thumbnail image validity determination unit 89 determines based on the thumbnail file and the FAT information whether a thumbnail image contained in a thumbnail file is valid for the Exif file. The thumbnail image validity determination unit 89 is realized when one of the CPU 41 and the CPU 51 of FIG. 1 performs predetermined processes. The display controller 90 controls the display 76 to display images. The display controller 90 corresponds to the LCD controller 57 of FIG. 1. The display 76 under the control of the display controller 90 displays images. The display 76 corresponds to the LCD 58 of FIG. 1, for example.

The recording and playback control block 77 controls the recording of data to the magneto-optic disk 21 and the playback of data from the magneto-optic disk 21. The recording and playback control block 77 includes a record controller 79 and a playback controller 80. The record controller 79 controls the recording of data on the magneto-optic disk 21. The playback controller 80 controls the playback of data from the magneto-optic disk 21. The recording and playback control block 77 (each of the record controller 79 and the playback controller 80) is realized when the media drive 13 of FIG. 1 performs predetermined processes.

The format of the Exif file generated by the Exif file generator 85 of FIG. 3 is described below with reference to FIGS. 4 and 5.

FIG. 4 generally illustrates the structure of one video file (Exif file). The video file includes compressed video data after a start of image (SOI) mark and immediately prior to an end of image (EOI) mark. Any information is contained in a header portion of the video file. The video file is hereinafter referred to as main image data.

One unit of information arranged in the header portion of the video file has an APP1 structure. An APP1 marker is arranged at the front of the APP1 information, followed by the data length of APP1, and an identifier of Exif file. Data of Exif (Exif IFD) is arranged next. Arranged at the end of the APP1 is thumbnail data which is the video signal in the reduced form thereof. In this embodiment, the thumbnail data is referred to as thumbnail image data. The APP1 information, which is one unit of information arranged in the header portion of the video file (Exif file), contains the thumbnail image data. The Exif file contains the main image data and the thumbnail image data.

The structure of the magneto-optic disk 21 loaded onto the recording and playback apparatus 1 of FIG. 1 is described below.

Physical attributes, such as a form factor, in the magneto-optic disk 21 are substantially identical to those in a disk used in the MD (Mini Disk) system. However, data recorded on the magneto-optic disk 21 and the arrangement of data on the disk are different from those in the known MD.

More specifically, the recording and playback apparatus 1 uses a FAT system as a file management system to record and play back content data such as audio data and video data.

The words FAT and FAT system are collectively used to refer to a file system of a variety of personal computers, and are not intended to refer to any particular one of FAT based file systems used in the disk operating system (DOS), VFAT (virtual FAT) used in Windows® 95/98, FAT32 used in Windows 98/ME/2000, and NTFS (New Technology File system). NTFS is a file system used in Windows® NT operating system or optionally in Windows® 2000, and records and retrieves files on a disk.

Two types of recording and playback formats are available. One format is based on specifications of the next-generation MD1, in which a disk identical to a disk used in the currently available MD system (namely, a physical medium) is used. The other format is based on specifications of the next-generation MD2. The next-generation MD2 is identical to the current MD system in terms of the disk, form factor, and external dimensions but provides increased recording capacity with increased recording density in a linear recording direction by means of magnetic super resolution (MSR).

The current MD system employs, as a recording medium, an magneto-optic disk having a diameter of 64 mm stored in a cartridge. The magneto-optic disk has a thickness of 1.2 mm, and a center hole having a diameter of 11 mm in the center thereof. The cartridge has a depth of 68 mm, a width of 72 mm, and a thickness of 5 mm.

The next-generation MD1 and the next-generation MD2 have the same disk dimensions and the same cartridge dimensions as those of the current MD system. The next-generation MD1 disk and the next-generation MD2 disk have a start position of the lead-in area at 29 mm as the disks of the current MD system.

The next-generation MD2 disk has a track pitch ranging from 1.2 μm to 1.3 μm (1.25 μm, for example). The next-generation MD1 uses the disks of the current MD system having a track pitch of 1.6 μm. Bit length is 0.44 μm/bit for the next-generation MD1 disk and 0.16 μm for the next-generation MD2 disk. Redundancy is 20.50% for both the next-generation MD1 disk and the next-generation MD2 disk.

Using the magnetic super resolution (MSR), the next-generation MD2 disks improve the recording capacity with increased linear velocity. In accordance with the MSR technology, a switching layer shifts into a magnetically neutral state if a predetermined temperature is reached. Domain wall transferred to a playback layer moves, thereby causing a tiny mark to look larger within a beam spot. This phenomenon is used.

The next-generation MD2 disk includes, on a transparent substrate, at least a laminate of a magnetic layer becoming a recording layer, a switching layer, and a magnetic layer for information playback purposes. The switching layer becomes an exchange coupling force adjusting layer. More specifically, if a predetermined temperature is reached, the switching layer shifts into a magnetically neutral state, thereby transferring the domain wall, transferred to the recording layer, to the magnetic layer. In response, a tiny mark appears larger within a beam spot. During recording, a laser pulse magnetic modulation technique is used to generate a tiny mark.

The next-generation MD2 disk uses a groove having a depth larger than that of the current MD disk and having a side wall inclined at a steeper angle in order to improve detrack margin, cross-talk from land, cross-talk of a wobble signal, and defocusing. More specifically, in the next-generation MD2 disk, the groove depth ranges from 160 nm to 180 nm, the inclination angle of the sidewall of the groove ranges from 60 degrees to 70 degrees, and the width of the groove ranges 600 nm to 700 nm.

In the optical specifications of the next-generation MD1, laser wavelength λ is 780 nm, and numerical aperture (NA) of an objective lens of an optical head is 0.45. In the specifications of the next-generation MD2 as well, laser wavelength λ is 780 nm, and the NA of the optical head is 0.45.

Both the next-generation MD1 and the next-generation MD2 uses a groove recording method. In other words, the groove is used as a track for recording and playback.

The current MD system uses, as an error correction encode, convolution code by advanced cross interleave Reed-Solomon coding (ACIRC). The next-generation MD1 and the next-generation MD2 use a block self-contained type code that is a combination of Reed Solomon Long Distance Code (RS-LDC) and a Burst Indicator Subcode (BIS). The use of the block self-contained type error correction code eliminates the need for using a linking sector. In the error correction method of a combination of the LDC and BIS, BIS allows an error location to be detected when a burst error takes place. An LDC code is used to perform an erasure correction in response to the error location.

A wobble groove method is employed as an addressing method. In the wobble groove method, a single spiral groove is formed, and a wobble is arranged on both sides of the groove as address information. Such addressing method is referred to as address in pregroove (ADIP). The current MD system is different from the next-generation MD1 and the next-generation MD2 in line density. The current MD system uses as the error correction code the convolution code referred to as ACIRC while the next-generation MD1 and the next-generation MD2 use a block self-contained code that is a combination of LDC and BIS. For that reason, redundancy becomes different, and relative positional relationship between ADIP and data becomes different. The next-generation MD1, which uses the disk having the same physical structure as the current MD system, handles ADIP in a manner different from the current MD. The next-generation MD2 uses the ADIP with the specification thereof modified in compliance therewith.

The current MD system uses eight to fourteen modulation (EFM) as a modulation method. The next-generation MD1 and the next-generation MD2 use run length limited (RLL)(1,7) parity preserve/prohibited (PP) repeated minimum transition runlength (RMTR) modulation, hereinafter simply referred to as 1-7 pp modulation. As a data detection method, the next-generation MD1 uses Viterbi decoding method of partial response PR(1,2,1) ML and the next-generation MD2 uses Viterbi decoding method of a partial response PR(1,−1) ML.

The disk control method is one of constant linear velocity (CLV) control method and zone constant angular velocity (ZCAV) control method. The standard linear velocity is 2.4 m/s for the next-generation MD1 and 1.98 m/s for the next-generation MD2. In the current MD, the linear velocity is 1.2 m/s for a 60-minute disk and 1.4 m/s for a 74-minute disk.

The next-generation MD1, which uses a current MD disk, provides an overall data recording capacity of 300 Mbytes per disk (on a 80-minute disk). With the modulation method changed from EFM to 1-7 pp modulation, the window margin changes from 0.5 to 0.666, leading to a 1.33 times higher density. With the error correction method changed from the ACIRC to the combination of BIS and LDC, data efficiency is increased, leading to a 1.48 times higher density. Even if the same disk as the one for the current MD is used, data capacity twice as large as the current MD is still achieved.

The next-generation MD2 disk using the MSR provides even higher density in linear direction, achieving about 1 Gbytes of overall data recording capacity.

Data rate at the standard linear velocity is 4.4 Mbits/s for the next-generation MD1 and 9.8 Mbits/s for the next-generation MD2.

With the improved error correction method and modulation method incorporated in this way, data recording capacity is increased in comparison with the current MD while data reliability is also enhanced at the same time.

FIG. 6 illustrates the next-generation MD1. The next-generation MD1 disk shares the disk structure of the current MD as is. More specifically, the next-generation MD1 disk includes a laminate of a dielectric layer, a magnetic layer, a dielectric layer, and a reflective layer disposed on a transparent polycarbonate substrate. The laminate is then covered with a protective layer.

As shown in FIG. 6, the next-generation MD1 disk includes a premastered table of content (P-TOC) in a lead-in area at the inner most circle of the disk recordable area in the radial direction of the disk. The P-TOC has a physically premastered structure. More specifically, control information is recorded in emboss pits as P-TOC information.

Outer circles outside the lead-in area as the P-TOC area form the recordable (magneto-optical recordable) area, and include a guide groove as a recording track. A user TOC (U-TOC) is arranged on the innermost circle of the recordable area.

The U-TOC has the same structure as the U-TOC of the current MD used to record the management information of the disk. The U-TOC is the management information that is updated in response to the sequential order of tracks (audio track and video data track), and recording and erasure of the tracks. The U-TOC is used to manage a start position, an end position, and a mode of each track.

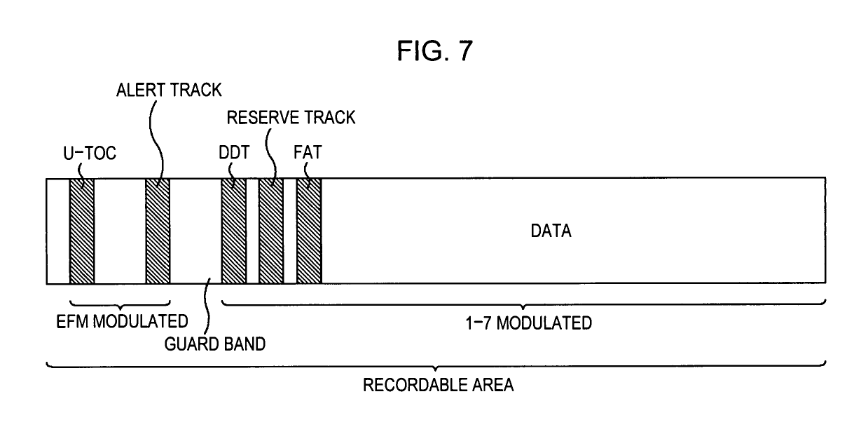

An alert track is arranged outside the U-TOC, and an alert sound is recorded on the alert track. If the disk is loaded onto the current MD, an alert sound is activated by an MD player. The alert sound is activated to indicate that the disk is played back on the next-generation MD1 player but not on the current MD player. The remaining recordable area (illustrated more in detail in FIG. 7) radially extends to a lead-out area.

FIG. 7 illustrates the recordable area of the next-generation MD1 disk of FIG. 6. As shown in FIG. 7, the U-TOC and the alert track are arranged on the head (the innermost circles) of the recordable area. In an area containing the U-TOC and the alert track, data is modulated by EFM so that the data can be played back on the current MD. Arranged outside the EFM modulated data area is an area where data is modulated with the 1-7 pp modulation. The EFM modulated data area and the 1-7 pp modulated data area are spaced apart from each other by a predetermined distance so that a guard band is arranged therebetween. The guard band prevents a current MD player from malfunctioning even if the next-generation MD1 disk is loaded onto the current MD player.

A discrete description table (DDT) area and a reserve track are arranged on the head (the innermost circles) of the 1-7 pp modulated data area. The DDT area is used to perform a backup process to back up any physically faulty area. A unique identification code is recorded on each disk on the DDT area. The identification code unique to each disk is referred to as a unique ID (UID). In the next-generation MD1, the UID is generated based on a generated random number, and recorded at an initialization process as will be described later. With the UID, security management of record content of the disk is performed. Information protecting the content is stored on the reserve track.

A FAT (file allocation table) area is arranged in the 1-7 pp modulated data area. In the FAT area, data is managed in the FAT system. Data management is performed in accordance with the FAT system of the host computer. The FAT system manages files in a FAT chain using a FAT table. Directories indicating files in a root directory and entry points of the directories, and link information of FAT clusters are described in the FAT table. The abbreviation FAT herein is comprehensively used to refer to a variety of file management methods used in personal computer operating systems.

In the next-generation MD1 disk, information concerning a start position of the alert track and information concerning a start position of the 1-7 pp modulated data area are recorded on the U-TOC area.

If the next-generation MD1 disk is loaded onto a current MD player, the U-TOC is read. The location of the alert track is learned from the information of the U-TOC, the alert track is accessed, and the playback of the alert track is started. The alert sound is recorded on the alert track to alert users that the disk is a next-generation MD1 disk and cannot be played back on the current MD system player. When the alert sound is activated, the user learns that that disk is not usable on the current MD system player.

When a next-generation MD1 disk is loaded onto a next-generation MD1 system player, the U-TOC information is read from the U-TOC area. The start position of the 1-7 pp modulated data area is learned from the U-TOC information. The DDT, the reserve track, and the FAT area are read. In the 1-7 pp modulated data area, data management is performed using the FAT system rather than the U-TOC.

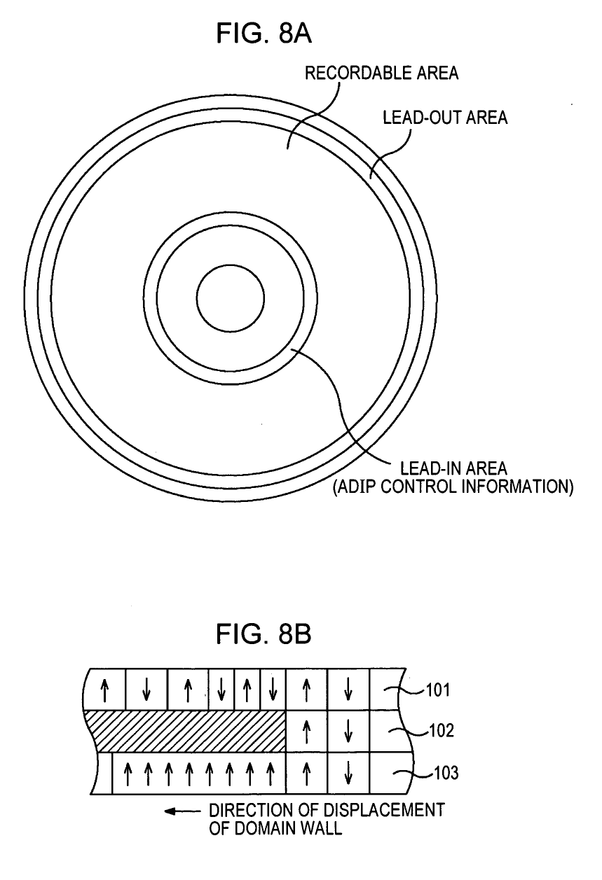

FIGS. 8A and 8B illustrate a next-generation MD2 disk. The next-generation MD2 disk includes a laminate of a dielectric layer, a magnetic layer, a dielectric layer, and a reflective layer disposed on a transparent polycarbonate substrate. The laminate is further covered with a protective layer.

In the next-generation MD2 disk, ADIP information as control information is recorded in the lead-in area on an inner circle of the disk as shown FIG. 8A. The next-generation MD2 disk includes no emboss pit P-TOC in the lead-in area, and uses instead the ADIP signal as the control information. The recordable area extends outside the lead-in area, and has a groove formed as a guide of the recording track. The recordable area bears 1-7 pp modulated data recorded thereon.

As shown in FIG. 8B, the next-generation MD2 disk includes a laminate of a magnetic layer 101 serving as a information recording layer, a switching layer 102, and a magnetic layer 103 for information playback. The switching layer 102 serves as an exchange coupling force adjusting layer. When a predetermined temperature is reached, the switching layer 102 shifts into a magnetically neutral state, and domain walls are transferred from the magnetic layer 101 to the playback magnetic layer 103. In the magnetic layer 101, a tiny mark appears expanded within a beam spot on the magnetic layer 103.

The above-referenced UID (not shown) is pre-recorded onto an area inside the recordable area of the next-generation MD2. Consumer recording and playback apparatuses permit playback from that area, but does not permit recording on that area. In the next-generation MD2 disk, the UID is pre-recorded during a manufacturing stage using a technique similar to the burst cutting area (BCA) technique used in the digital versatile disk (DVD). Since the UID is pre-recorded during the manufacture of the disk, subsequent management of the UID becomes easy. Security level is higher than in the next-generation MD1 disk where the UID is generated based on a random number at the initialization of the disk.

To simplify explanation, the area with the UID pre-recorded thereon in the next-generation MD2 disk is hereinafter referred to as a BCA area.

The information of the lead-in area discriminates between the next-generation MD1 and the next-generation MD2. More specifically, if a P-TOC in emboss pit is detected in the lead-in area, the disk is one of a current MD disk and a next-generation MD1 disk. If the control information responsive to the ADIP signal is detected with the P-TOC in emboss pit undetected, the disk is a next-generation MD2 disk. The determination of whether the UID is pre-recorded on the BCA area is also used to identify the disk type. The determination of the next-generation MD1 disk and the next-generation MD2 disk is not limited to these methods. The phase of a tracking error signal during on-track period and off-track period serves as a determination criterion of the disk type. Alternatively, a disk type identifying slot can be arranged in each disk.

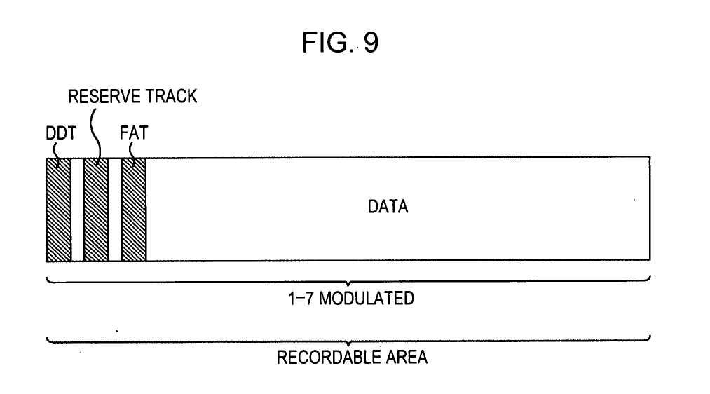

FIG. 9 illustrates the recordable area of the next-generation MD2 disk. As shown in FIG. 9, data is modulated on the entire recordable area using the 1-7 pp modulation technique. The DDT area and the reserve track are arranged on the front (inner circles) of the 1-7 pp modulated data area. The DDT area is used to record backup area management data thereon to manage backup areas for any physically faulty area.

More specifically, a management table is recorded on the DDT area. The management table manages backup areas including the recordable area to compensate for a physically faulty area. The management table stores a logical cluster determined as being faulty, and records at least one logical cluster within the backup area assigned instead of the faulty logical cluster. The UID is recorded on the DDT area. The reserve track stores information for protecting a content.

An FAT area is arranged in the 1-7 pp modulated data area. The FAT area is used to manage data in the FAT system. Data is managed in accordance with the FAT system of each general-purpose personal computer.

The next-generation MD2 disk is not provided with the U-TOC area. If a next-generation MD2 disk is loaded onto a next-generation MD2 system player, the DDT, the reserve track, and the FAT information are read from the predetermined areas, and data management is performed using the FAT system.

The next-generation MD1 disk and the next-generation MD2 disk are free from time-consuming initialization process. More specifically, in the next-generation MD1 disk and the next-generation MD2 disk, the initialization process is not required except that a minimum amount of job including production of the DDT, the reserve track, and the FAT table. Recording and playback operation is directly performed on the recordable area on a new disk.

Since the UID is pre-recorded in the next-generation MD2 disk during the manufacturing stage thereof, security management is more effectively performed. On the other hand, however, the next-generation MD2 disk having layers larger than the number of layer in the current MD disk is more expensive. One disk system has been proposed. The proposed disk is made identical to the next-generation MD1 disk in the structure of the recordable area, the lead-in area and the lead-out area. The UID is pre-recorded on the disk at the manufacturing stage using the BCA as in the DVD and the next-generation MD2. This proposed disk is referred to as a next-generation MD1.5.

The next-generation MD1.5 disk is compatible with the next-generation MD2 disk in the structure of the UID, and compatible with the next-generation MD1 disk in audio data recording and playback operation. No further discussion is provided to the next-generation MD1.5 herein.

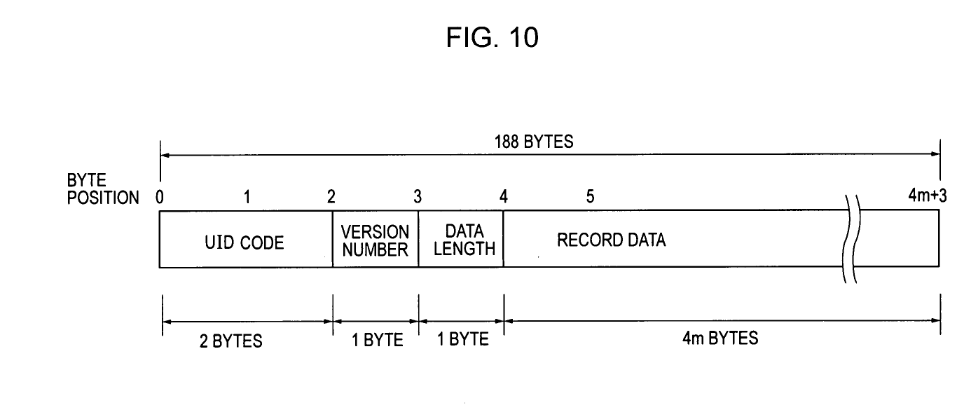

The UID is described further in detail. As previously discussed, the UID is pre-recorded on the next-generation MD2 disk during the manufacture of the disk using the technique similar to the BCA technique used in the manufacture of the DVD. FIG. 10 diagrammatically illustrates one example of the UID. The whole UID is referred to as a UID record block.

In the UID record block, 2 bytes from the head is a field for a UID code. The upper 4 bits of the 2 bytes, namely, 16 bits of the UID code are used for disk type determination. For example, 4 bits of “0000” indicates that the disk is a next-generation MD2 disk, and 4 bits of “0001” indicates that the disk is a next-generation MD1.5 disk. The other values of the upper 4 bits of the UID code may be reserved for future use. The lower 12 bits of the UID code is used as an application ID, and can identify a total of 4096 types of service.

The UID code is followed by a field of a version number of 1 byte, and then followed by a field of a data length of 1 byte. The data length indicates the length of the field of a UID record data arranged in succession to the data length. The field of the UID record data is assigned 4m bytes (m=0, 1, . . . ) under the condition that the data length of the entire UID does not exceed 188 bytes. A unique ID generated using a predetermined method is stored in the field of the UID record data. In this way, the disk is individually identified.

In the next-generation MD1 disk, an ID generated based on a random number is recorded on the field of the UID record data.

The UID record block has a maximum data length of 188 bytes, and a plurality of UID record blocks can be arranged.

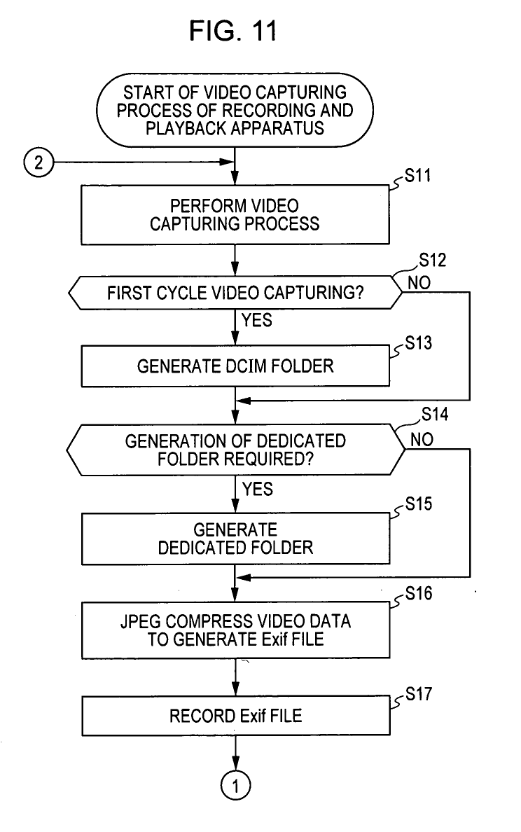

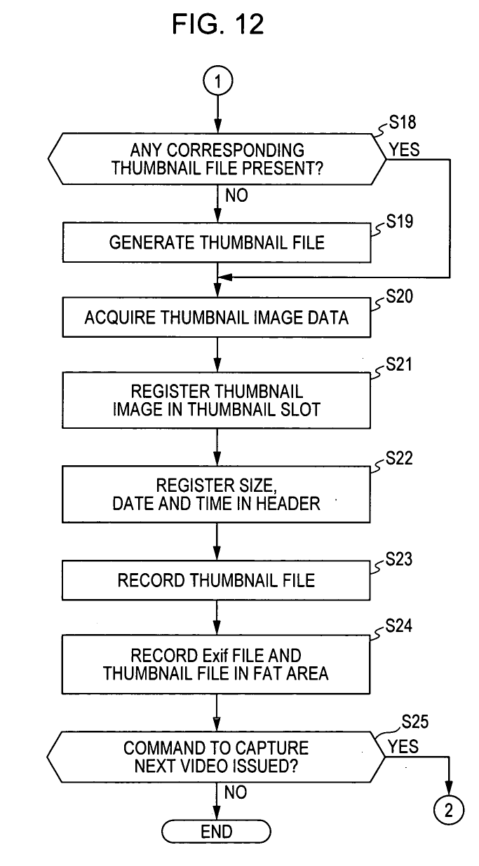

A video capturing process of the recording and playback apparatus 1 of FIG. 3 is described below with reference to flowcharts of FIGS. 11 and 12. The video capturing process starts when the user enters a command to capture video to the operation input unit 14. The video capturing process also starts with the magneto-optic disk 21 loaded on the recording and playback apparatus 1 of FIG. 3.

In step S11, the CCD 53 in the recording and playback apparatus 1 picks up an image of a subject. More specifically, a user enters a command to capture video to the operation input unit 14. In response, the operation input unit 14 feeds a control signal responsive to the input command to the main controller 71. Since the user command is a video capturing command, the main controller 71 commands the video processor 75 to capture video. The video processor 75 commands the CCD 53 to pick up the image of the subject. In response to the command, at a predetermined timing (at the timing a control signal is supplied from the video processor 75), the CCD 53 converts an optical image entering through the lens 52 (see FIG. 1) to an electrical signal of a voltage value provided by each pixel by means of the photoelectric conversion effect thereof. The CCD 53 supplies the video data acquisition unit 82 in the video processor 75 with the electrical signal as a video signal. The video data acquisition unit 82 performs a variety of processes on the video signal, thereby resulting in the video data. When the user enters the video capturing command to the operation input unit 14, the user can also specify an image size, and a location (folder) to store a generated file.

In step S12, the video processor controller 81 in the video processor 75 determines whether the video capturing video is a first cycle to the magneto-optic disk 21. For example, the video processor controller 81 causes the playback controller 80 in the recording and playback control block 77 to read the FAT information (information stored in the FAT area) stored on the magneto-optic disk 21. If an image captured in the first cycle is stored onto the magneto-optic disk 21, a DCIM (Digital Camera IMage) folder is generated. The video processor controller 81 references the FAT area to determine whether a DCIM folder is present, in other words, whether a first image is being captured.

If it is determined in step S12 that the first cycle image is being captured, the folder generator 84 generates a DCIM folder in step S13.

If it is determined in step S12 that the image being captured is not first, processing proceeds to step S14 with step S13 skipped.

Processing proceeds to step S14 if it is determined in step S12 that the image being captured is not the first or subsequent to step S13. The video processor controller 81 determines in step S14 whether it is necessary to produce a dedicated folder storing a file for the captured video data. The dedicated folder is produced under the DCIM folder, and holds the file of the captured video data. The name of the dedicated folder is different from manufacturer to manufacturer. One manufacturer refers to the dedicated folders as “100”, “101”, “102”, . . . , “999”. In this case, the video processor controller 81 determines based on the FAT information whether any file having one of these file names is contained in the DCIM folder of the magneto-optic disk 21. If the determination in step S14 is performed subsequent to step S13, in other words, if it is determined that the image being captured is first, any dedicated folder is not yet produced. In this case, if it is determined in step S14 that it is necessary to produce a dedicated folder. If a folder storing the captured video data has a folder name “B100” named by another manufacturer and contained in the DCIM folder, the video processor controller 81 also determines that it is necessary to produce a dedicated folder.

If it is determined in step S14 that it is necessary to produce a dedicated folder, the folder generator 84 generates a dedicated folder in step S15. For example, the folder generator 84 generates a dedicated folder having a folder name “100”.

If it is determined in step S14 that it is not necessary to produce a dedicated folder, processing proceeds to step S16 with step S15 skipped.

If it is determined in step S14 that it is not necessary to produce a dedicated folder, or subsequent to step S15, the Exif file generator 85 under the control of the video processor controller 81 JPEG compresses the captured video data to generate an Exif file in step S16. More specifically, the Exif file generator 85 under the control of the video processor controller 81 compresses, in accordance with JPEG algorithm, the video data captured in step S11 and acquired by the video data acquisition unit 82, and performs a variety of processes. The Exif file generator 85 thus produces an Exif file in the format discussed with reference to FIGS. 4 and 5. The recorded video data of FIG. 4, i.e., standard video data is hereinafter referred to main image data. Thumbnail data contained in the APP1 of FIG. 4 is hereinafter referred to as thumbnail image data. The Exif file generator 85 attaches name “yyy0001.jpg” to the generated Exif file, for example, and supplies the Exif file to the video data acquisition unit 82. The video data acquisition unit 82 thus acquires the Exif file.

In step S17, the record controller 79 causes the magneto-optic disk 21 to store the Exif file supplied from the video data acquisition unit 82 (the Exif file generated by the Exif file generator 85). The recording location of the Exif file is under the DCIM folder, i.e., the dedicated folder. If it is determined in step S14 that a dedicated folder is produced, the Exif file is recorded in the dedicated folder. If it is determined in step S14 that it is necessary to produce a dedicated folder, the Exif file is recorded in a dedicated folder produced in step S15. For example, “yyy001.jpg” is recorded in the directory “root/DCIM/100” of the magneto-optic disk 21.

In step S18, the thumbnail file identifying unit 88 under the control of the video processor controller 81 determines whether a corresponding thumbnail file is present. As shown in FIG. 13, the thumbnail file name corresponding to the name of the Exif file is determined and stored in the table memory 83 in the recording and playback apparatus 1. The table of FIG. 13 is defined in a video capturing program and stored beforehand.

For a thumbnail file name “0001.thm”, Exif files of “yyy0001.jpg through “yyy0100.jpg” are available. For a thumbnail file name “0101.th”, Exif files of “yyy0101.jpg through “yyy0200.jpg” are available. Similarly, for a thumbnail file name “9901.thm”, Exif files of “yyy9901.jpg through “yyy9999.jpg” are available. In this way, for a single thumbnail file, 100 Exif files are available (except thumbnail file name “9901.jpg”). In this example, the thumbnail file name (file base name) except the extension thereof is the same as a portion of the file name (file base name) of the first of 100 Exif files. By setting the portion of the file name of the first Exif file except the extension to be identical to the portion of the thumbnail file name, the user can easily identify the thumbnail file stored in the folder.

The thumbnail file identifying unit 88 references the information of the FAT area and the table stored in the table memory 83 to determine whether the thumbnail file corresponding to the name of the Exif file generated in step S16 is recorded in the magneto-optic disk 21. More specifically, if the Exif file having the file name “yyy0001.jpg” is generated in step S16, the thumbnail file identifying unit 88 determines in the case of FIG. 13 whether a file having the thumbnail file name “0001.thm” is stored in the magneto-optic disk 21. If this determination process is performed subsequent to step S13 or step S15, no corresponding thumbnail file is naturally stored. It is determined in step S18 that no corresponding thumbnail file is available.

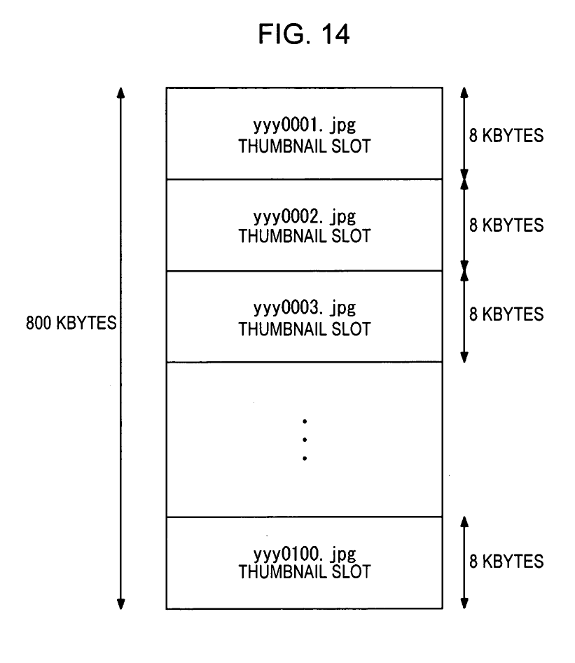

If it is determined in step S18 that no corresponding thumbnail file is available, processing proceeds to step S19. The thumbnail file generator 86 under the control of the video processor controller 81 generates a thumbnail file. More specifically, as shown in FIG. 14, the thumbnail file generator 86 generates a thumbnail file having 100 thumbnail slots. These thumbnail slots are currently empty (for example, are loaded with zero values) as shown in FIG. 14. In this case, the Exif file having the Exif file having name “yyy0001.jpg” is generated in step S16, and the thumbnail file (see FIG. 14) having the name “0001.thm” is generated as shown in FIG. 13.

FIG. 14 illustrates the structure of the thumbnail file “0001.thm”.

A single thumbnail file has 100 thumbnail slots so that thumbnail image data corresponding to 100 Exif files can be written on the single thumbnail file. In accordance with the present embodiment, an area for the thumbnail image data corresponding to a single Exif file (i.e., an area for a single thumbnail slot) has 8 Kbytes, and the thumbnail image data of the 100 Exif files can be written on the single thumbnail file. The single thumbnail file has thus 800 Kbytes.

The thumbnail file is divided into 800 partitions as areas of the thumbnail image data corresponding to respective Exif files. As shown in FIG. 14, a first row is referred to as “yyy0001.jpg thumbnail slot” and has an empty area of 8 Kbytes for the thumbnail image data of the Exif file “yyy0001.jpg”. In other words, the “yyy0001.jpg thumbnail slot” is an area of the thumbnail image data corresponding to the “yyy0001.jpg” Exif file.

Arranged on a second row and subsequent rows of FIG. 14 are “yyy002.jpg thumbnail slot”, “yyy0003.jpg thumbnail slot”, . . . , “yyy0100.jpg thumbnail slot” as reserved empty areas (slots). Each thumbnail slot area has a size of 8 Kbytes. When a thumbnail file is first generated, areas for 100 units of the thumbnail image data are reserved so that thumbnail image data is successively recorded. Reading of the thumbnail file is thus quickly performed.

Returning to FIG. 12, if it is determined in step S18 that the corresponding thumbnail file is present, or subsequent to step S19, processing proceeds to step S20. The thumbnail file generator 86 acquires the thumbnail image data from the Exif file. More specifically, the thumbnail file generator 86 acquires the thumbnail data contained in the Exif file generated in step S16 (thumbnail data of FIG. 5 contained in APP1 in the Exif file of FIG. 4). For example, the thumbnail file generator 86 acquires the thumbnail image data from the Exif file “yyy0001.jpg”.

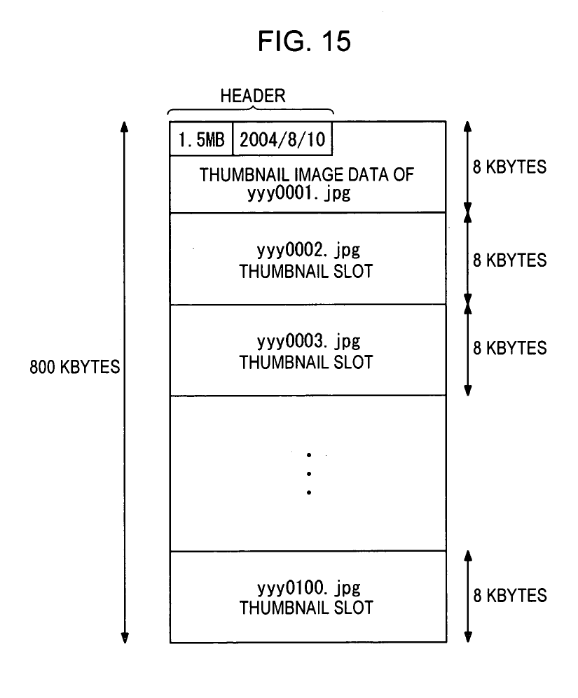

In step S22, the thumbnail file generator 86 registers the acquired thumbnail image (thumbnail image data) in a slot corresponding to the thumbnail file. For example, if the thumbnail image data is acquired from the Exif file “yyy0001.jpg”, the thumbnail image data is registered as “thumbnail image data of yyy0001.jpg” on the “yyy0001.jpg thumbnail slot” as a slot corresponding to the Exif file. As shown in FIG. 15, the “thumbnail image data of yyy0001.jpg” is registered in the “yyy0001.jpg thumbnail slot”.

In step S22, the thumbnail file generator 86 registers size and date and time. More specifically, the thumbnail file generator 86 registers the data size of the Exif file “yyy0001.jpg” and the date and time of recording of the Exif file as the thumbnail image data (for example, as a header of the “thumbnail image data of yyy0001.jpg”). The data size of the Exif file is recorded in 0th IFD of FIG. 5, and the date and time of production of the Exif file are written on Exif IFD of FIG. 5. The thumbnail file generator 86 acquires these units of information from the Exif file, and registers these units of information on the area (header) of the thumbnail file.

As shown in FIG. 15, a thumbnail file “0001.thm” corresponding to the generated Exif file “yyy0001.jpg” is generated.

Referring to FIG. 15, the data size and the date and time of production of the Exif file “yyy0001.jpg” are written as a header on the top left corner of the area of the “thumbnail image data of yyy0001.jpg” (namely, the “yyy0001.jpg thumbnail slot”). The data size of the Exif file “yyy0001.jpg” is 1.5 MB (megabytes), and the date and time of recording of the Exif file are Aug. 8, 2004. In practice, not only date but also time is written. For simplicity, only the date is shown. The “thumbnail image data of yyy0001.jpg” on the first row is data stored in step S20. The header of “1.5 MB” and “Aug. 10, 2004” are data stored in step S21.

In this way, the thumbnail image data acquired from the Exif file, the data size of the Exif file, and the date and time of production of the Exif file are registered in the thumbnail slot.

Returning to FIG. 12, the record controller 79 in the recording and playback control block 77, under the control of the video processor controller 81, causes the magneto-optic disk 21 to store the thumbnail file. The thumbnail file is stored in the same location as the corresponding Exif file, i.e., in the directory “root/DIM/100”. If a thumbnail file having the same thumbnail file name is already recorded, the thumbnail file overwrites (updates) the preceding file.

As shown in FIG. 16, “yyy0001.jpg” (Exif file) and “0001.thm” (thumbnail file) are currently recorded in “root/DCIM/100” of the magneto-optic disk 21. The data size of the “yyy0001.jpg” is 1.5 MB, and the date and time of production is Aug. 10, 2004. More specifically, the data size of the “yyy0001.jpg” and the date and time of production match header information of the “thumbnail image data of yyy0001.jpg” stored in the first slot of the thumbnail file. The data size of the “0001.thm” is 0.8 MB, and the date and time of production (update) is Aug. 10, 2004.

The sizes of all generated thumbnail files are set to be equal to each other. The thumbnail file set herein is set to a data size convenient to store in consecutive areas on the optical disk, i.e., to a relatively small data size. In accordance with the present embodiment, the size of each thumbnail file is set to 0.8 Mbytes (800 Kbytes) so that the thumbnail file is easy to be recorded on the magneto-optic disk 21.

The data size of the thumbnail file is 0.8 MB. The data size is not limited to 0.8 MB. A data size accommodated by a low-capacity memory in a mobile apparatus is perfectly acceptable. For example, a data size smaller than the overall data size of a plurality of Exif files can be used.

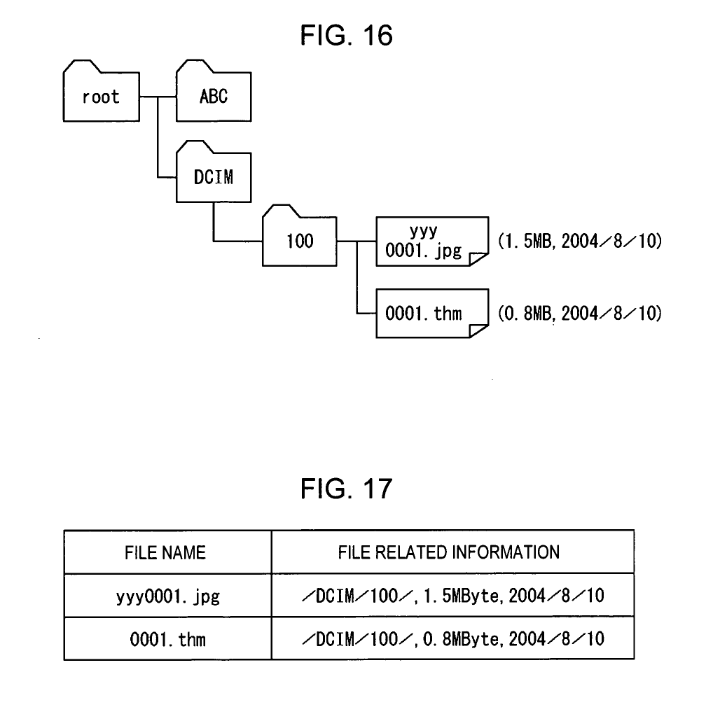

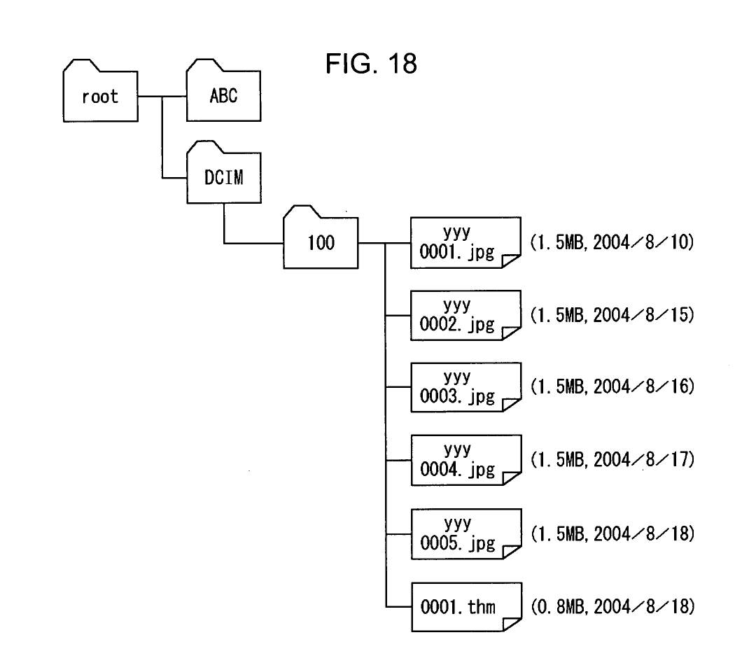

Returning to FIG. 12, the FAT information processor 87 controls in step S24 the record controller 79 in the recording and playback control block 77 to record (update) the Exif file and information concerning the thumbnail file on the FAT area of the magneto-optic disk 21. This step is intended to update the Exif file recorded in step S17 and the thumbnail file recorded in step S23. In response, the record controller 79 records (updates) the information concerning the Exif file and the thumbnail file on the FAT area of the magneto-optic disk 21. More specifically, the record controller 79 under the control of the FAT information processor 87 registers a “file name” and file related information corresponding to the file name on a table shown in FIG. 17 recorded on the FAT area of the magneto-optic disk 21. The file related information contains the location of the recorded file, the data size of the file, and the date and time of production of the file. In practice, information indicating relationship with the directory entry, address, and other information are also registered. These units of information are not directly related to the present invention and are not discussed further.

As shown in FIG. 17, the related information of the Exif file “yyy0001.jpg” includes “/DCIM/100” as the storage location of the file, “1.5 MB” and the file data size, and “Aug. 10, 2004” as the date and time of production of the file. The related information of the thumbnail file “0001.thm” includes “/DCIM/100” (“root/” is omitted because the root directory is common) as the storage location of the file, “0.8 MB” as the data size of the file, and “Aug. 10, 2004” as the date and time of production of the file. In the case of FIG. 17, the related information of the Exif file “yyy0001.jpg” matches the information of the header of FIG. 15.

The image of the subject is thus picked up, and the Exif file and the thumbnail file are generated (or updated), and stored onto the magneto-optic disk 21.

Returning to FIG. 12, the video processor controller 81 in the video processor 75 determines in step S25 whether a next command to capture video has been issued (i.e., whether a command to capture video has been entered to the operation input unit 14). If it is determined that the video capturing command has been issued, processing returns to step S11 to repeat step S11 and subsequent steps.

The video capturing process of second and subsequent cycles is briefly described below. In step S11, an image is picked up. It is determined in step S12 whether the video capturing process is not first. It is determined in step S14 that it is not necessary to generate a dedicated folder. This is because the DCIM folder and the dedicated folder (the folder having the folder name “100”) are produced in steps S13 and S15 in the first cycle. In step S16, an Exif file is generated. A file name “yyy0002.jpg” is attached to the generated Exif file. The number in the file name is incremented by one herein. Alternatively, a random name can be attached to avoid duplication. In step S17, the Exif file “yyy0002.jpg” is recorded in “root/DCIM/100”.

As shown in FIG. 13, a thumbnail file corresponding to “yyy0002.jpg” is “0001.thm”. It is determined in step S18 that a corresponding thumbnail file is available. In step S20, thumbnail image data is acquired. In this case, thumbnail data contained in the Exif file “yyy0002.jpg” is acquired as the thumbnail image data. In step S21, the thumbnail image data is registered in a thumbnail slot corresponding to the thumbnail file, in this case, in the “yyy0002.jpg thumbnail slot” of the thumbnail file “0001.thm”. In step S22, the size and date and time of the “yyy0002.jpg” are registered in the header of an area (thumbnail slot) where the thumbnail image data of “yyy0002.jpg” is stored. In step S23, the thumbnail file is updated. In step S23 in the second cycle, the same thumbnail file name has been already recorded on the magneto-optic disk 21, and the thumbnail file is updated. In step S24, the information related to the Exif file “yyy0002.jpg” and the thumbnail file “0001.thm” is recorded (updated).

If it is determined in step S25 that a command to perform no next video capturing cycle has been issued (for example, if one of a video capturing end command and a switch-off command has been issued), processing ends.

The recording and playback apparatus 1 generates the Exif file after capturing video in accordance with the process of FIGS. 11 and 12. The recording and playback apparatus 1 then generates the thumbnail file based on the Exif file. The thumbnail file contains 100 thumbnail slots. Each thumbnail slot stores the thumbnail image data corresponding to the Exif file, the data size of the corresponding Exif file, and the date and time of production of the corresponding Exif file.

To record the Exif file, a new thumbnail file is generated if no corresponding thumbnail file is present. The thumbnail image data acquired (copied) from the Exif file is stored in the thumbnail slot of the thumbnail file. To record the Exif file, the thumbnail image data acquired (copied) from the Exif file is stored in the existing thumbnail file if the corresponding existing thumbnail file is present. The thumbnail file is thus generated and/or updated. The thumbnail image data separately stored in a plurality of Exif files can be collected to form a single thumbnail file.

The Exif file and the thumbnail file generated by repeating the process of FIGS. 11 and 12 are described below.

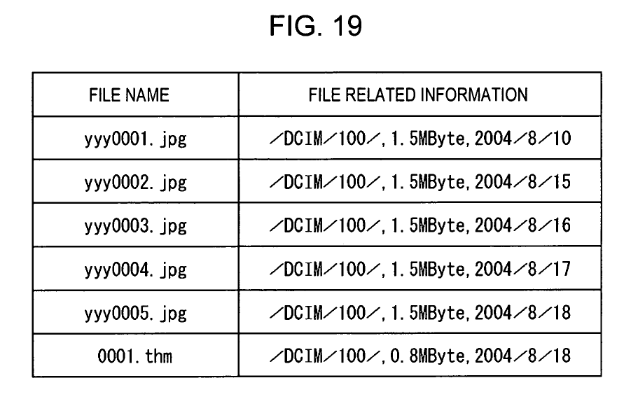

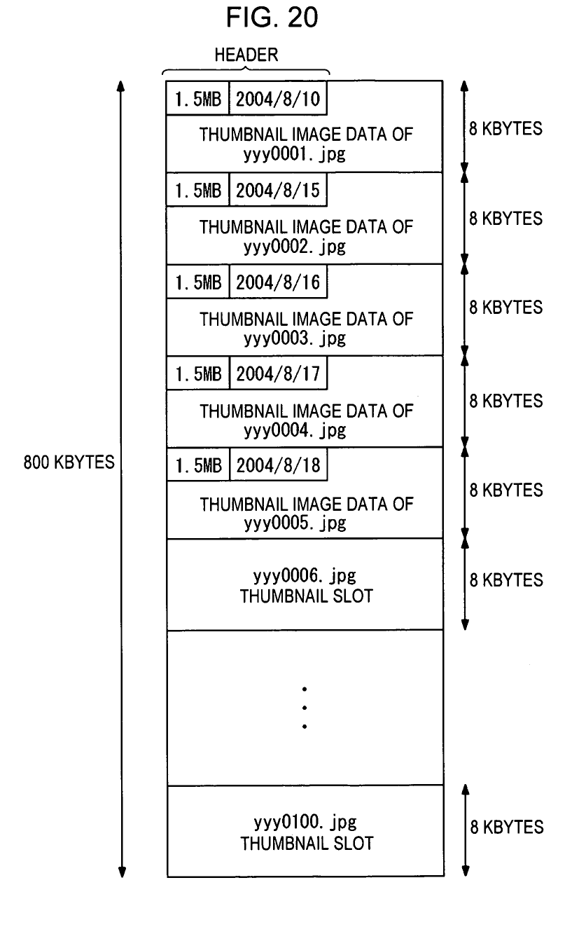

FIG. 18 illustrates a file and a folder registered in a root folder. FIG. 19 illustrates information managed in the FAT area in the state of FIG. 18. FIG. 20 illustrates the thumbnail file in the state shown FIGS. 18 and 19.

As shown in FIG. 18, folders “ABC” and “DCIM” are contained in the root folder. The folder “DCIM” contains a folder “100”. The folder “100” contains Exif files of “yyy0001.jpg”, “yyy0002.jpg”, “yyy0003.jpg”, “yyy0004.jpg”, and “yyy0005.jpg”, and thumbnail file “0001.thm”. More specifically, the repetition of the process of FIGS. 11 and 12 results five Exif files and one thumbnail file corresponding thereto. The Exif file “yyy0001.jpg” has a data size of 1.5 MB and the date and time of production of Aug. 10, 2004. The Exif file “yyy0002.jpg” has a data size of 1.5 MB and the date and time of production of Aug. 15, 2004. The Exif file “yyy0003.jpg” has a data size of 1.5 MB and the date and time of production of Aug. 16, 2004. The Exif file “yyy0004.jpg” has a data size of 1.5 MB and the date and time of production of Aug. 17, 2004. The Exif file “yyy0005.jpg” has a data size of 1.5 MB and the date and time of production of Aug. 18, 2004. The thumbnail file “0001.thm” has a data size of 0.8 MB, and the date and time of update of Aug. 18, 2004. The date and time of update of the thumbnail file “0001.thm” is identical to those of the latest Exif file among the plurality of corresponding Exif files. As shown in FIG. 18, the corresponding Exif files are from yyy0001.jpg to yyy0005.jpg, and the latest Exif file yyy0005.jpg has the same date and time as the thumbnail file.

Information shown in FIG. 19 is managed in the FAT area. More specifically, the related information of the Exif file “yyy0001.jpg” contains “/DCIM/100” as the storage location of the file, “1.5 MB” as the data size of the file, and “Aug. 10, 2004” as the date and time of production of the file. The related information of the Exif file “yyy0002.jpg” contains “/DCIM/100” as the storage location of the file, “1.5 MB” as the data size of the file, and “Aug. 15, 2004” as the date and time of production of the file. Similarly, the related information of other Exif files is recorded and managed. The related information of the thumbnail file “0001.thm” contains “/DCIM/100” as the storage location of the file, “0.8 MB” as the data size of the file, and “Aug. 18, 2004” as the date and time of production of the file. In this way, the information of the file actually recorded on the disk as shown in FIG. 18 matches information registered in the FAT area of FIG. 19. By referencing the information managed in the FAT area of FIG. 19, a file stored in a folder can be learned. The date and time of production (update) of the file and the data size of the file are also learned.

As shown in FIG. 20, the thumbnail image data corresponding to the Exif files of “yyy0001.jpg through yyy0005.jpg” is stored in the thumbnail file. Only the thumbnail image data corresponding to the Exif file “yyy0001.jpg” is registered in the thumbnail file “0001.thm” in the state of FIG. 15. Further to the thumbnail image data of FIG. 15, the “thumbnail image data of yyy0002.jpg” through “thumbnail image data of yyy0005.jpg” and headers corresponding thereto are registered in the “yyy0002.jpg thumbnail slot” through “yyy0005.jpg thumbnail slot” as shown in FIG. 20. More specifically, the thumbnail image data (see FIG. 5) registered in the Exif file “yyy0002.jpg” is acquired and then registered in the “yyy0002.jpg thumbnail slot” of FIG. 15. Similarly, the thumbnail image data registered in the Exif files “yyy0003.jpg” through “yyy0005.jpg” is registered in the “yyy0003.jpg thumbnail slot” through the “yyy0005.jpg thumbnail slot”. The date and time of production of each of the Exif files (“yyy0001.jpg” through “yyy0005.jpg”) shown in FIG. 5 is registered in the corresponding header of the corresponding thumbnail slot. The thumbnail image data and the headers of the “yyy0001.jpg through yyy0005.jpg” are registered.

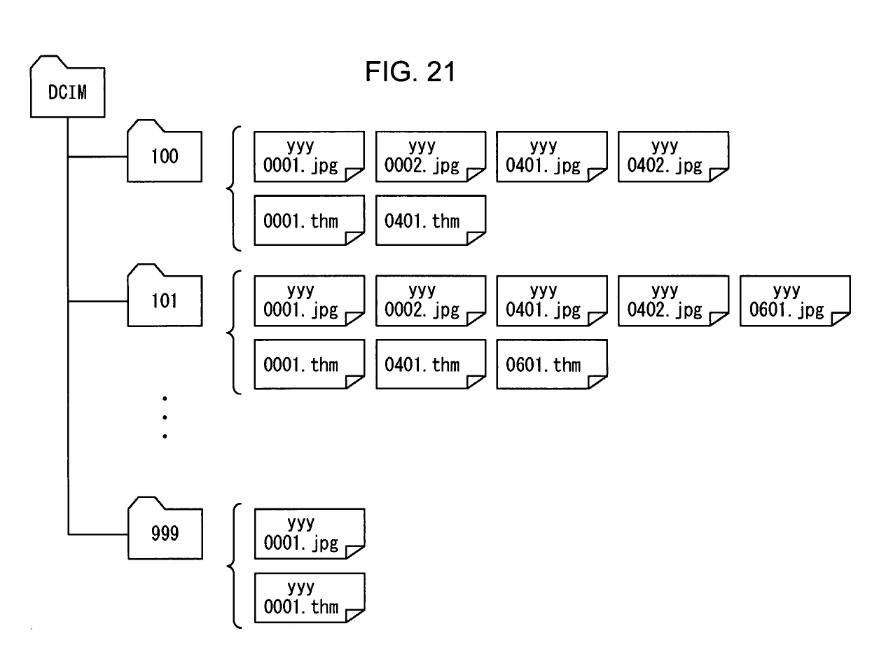

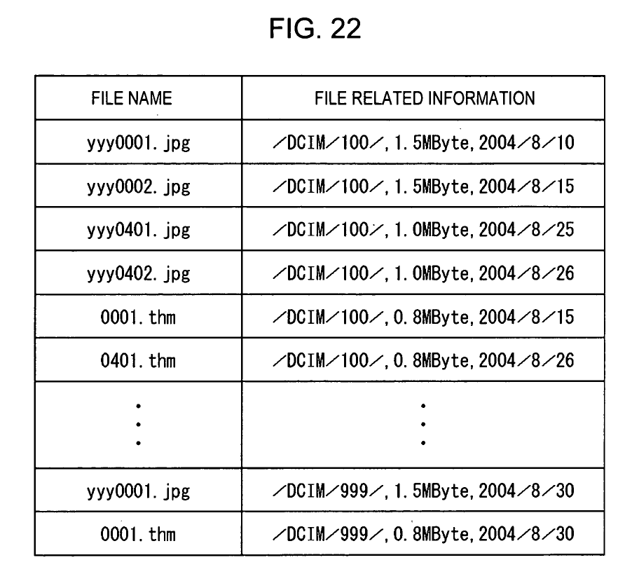

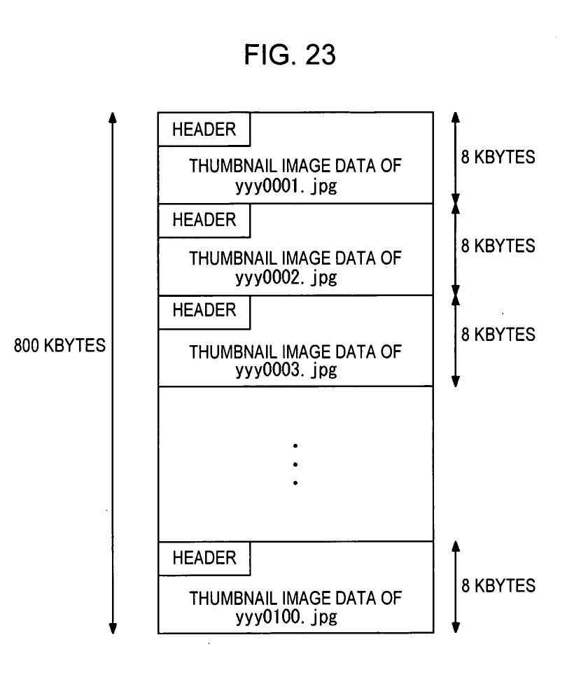

FIG. 21 illustrates files and headers registered in the root folder. FIG. 22 illustrates information managed in the FAT area in the state shown in FIG. 21. FIG. 23 illustrates the thumbnail file in the states shown in FIGS. 21 and 22. The DCIM folder is contained in the root folder in practice, but the root folder is not shown for simplicity in FIG. 21.

As shown in FIG. 21, the folder DCIM contains folders “100”, “101”, . . . , “999”. Data resulting from the video capturing process is stored in the folders “100” through “999”. The folder “100” contains four Exif files “yyy0001.jpg”, “yyy0002.jpg”, “yyy0401.jpg” and “yyy0402.jpg” and two thumbnail files “0001.thm” and “0401.thm”. The thumbnail image data corresponding to two Exif files “yyy0001.jpg” and “yyy0002.jpg” is registered in “0001.thm”. The thumbnail image data corresponding to two Exif files “yyy0401.jpg” and “yyy0402.jpg” is registered in “0401.jpg” (see the table FIG. 13). The folder “101” contains five Exif files “yyy0001.jpg”, “yyy0002.jpg”, “yyy0401.jpg”, “yyy0402.jpg” and “yyy0601.jpg” and three thumbnail files “0001.thm”, “0401.thm” and “0601.thm”. The thumbnail image data corresponding to two Exif files “yyy0001.jpg” and “yyy0002.jpg” is registered in “0001.thm”. The thumbnail image data corresponding to two Exif files “yyy0401.jpg” and “yyy0402.jpg” is registered in “0401.thm”. The thumbnail image data corresponding to two Exif files “yyy0601.jpg” is registered in “0601.thm” (see the table FIG. 13). Similarly, the folder “999” contains the Exif file “yyy0001.jpg” and the thumbnail file “0001.thm”. The thumbnail image data corresponding to the Exif file “yyy0001.jpg” is registered in “0001.thm” of this folder (see the table of FIG. 13).

By repeating the process of FIGS. 11 and 12, the Exif files and the thumbnail files are produced under the folders “100” through “999”. When the user issues a command to capture video in step S11 as shown in FIG. 11, the user can specify the storage location (i.e., folder) of the captured video data (i.e., Exif file) within the DCIM folder. In response to the user operational input, a plurality of folders are produced within the DCIM folder.

A predetermined number of files (for example, 1000 files) within a number range to a predetermined number (for example, 0001 through 0999) are stored in the dedicated folders (“100”, “101”, . . . , “999”). For example, after 1000 files are recorded in the dedicated folder “100” in response to a user command, video capturing is performed. The folder “101” is generated, and files obtained as a result of video capturing are recorded in the folder “101”. For example, files 0001 (corresponding to the number yyy0001.jpg in the present embodiment) through 0999 (corresponding to the number yyy0999.jpg) are successively recorded. When the video capturing command is issued again, it is determined in step S14 that it is necessary to generate a dedicated folder, and then the folder “101” is generated. The files obtained as a result of video capturing are stored in the folder “101”.

As shown in FIG. 21, the information of FIG. 22 is managed in the FAT area. In FIG. 22, elements that have already been described with reference to FIG. 19 are not described herein. As shown in FIG. 22, the related information of the Exif file “yyy0401.jpg” stored in the folder “DCIM/100” contains “/DCIM/100” as the storage location of the file, “1.0 MB” as the data size of the file, and “Aug. 25, 2004” as the date and time of production of the file. In the video capturing process corresponding to the Exif file “yyy0401.jpg”, the data size of the file is changed to “1.0 MB” from “1.5 MB” for “yyy0001.jpg”. This means that the user has entered an operational input command to change a recording mode (to change resolution, for example) of the file to the operation input unit 14. The related information of the Exif file “yyy0402.jpg” contains “/DCIM/100” as the storage location of the file, “1.0 MB” as the data size of the file, and “Aug. 26, 2004” as the date and time of production of the file. The related information of the thumbnail file “0001.thm” contains “/DCIM/100” as the storage location of the file, “0.8 MB” as the data size of the file, and “Aug. 15, 2004” as the date and time of production of the file. The related information of the thumbnail file “0401.thm” contains “/DCIM/100” as the storage location of the file, “0.8 MB” as the data size of the file, and “Aug. 26, 2004” as the date and time of production of the file. Similarly, files “yyy0001.jpg”, “yyy0002.jpg”, “yyy0401.jpg”, “yyy0402.jpg”, and “yyy0601.jpg”, and “0001.thm”, “0401.thm”, and “0601.thm” stored in the folder “/DCIM/101” contain similar related information. The related information of the Exif file “yyy0001.jpg” stored in the folder “DCIM/999” contains “/DCIM/999” as the storage location of the file, “1.5 MB” as the data size of the file, and “Aug. 30, 2004” as the date and time of production of the file. The related information of thumbnail file “0001.thm” contains “/DCIM/999” as the storage location of the file, “0.8 MB” as the data size of the file, and “Aug. 30, 2004” as the date and time of production of the file. The information of the files actually recorded on the disk as shown in FIG. 21 matches the information registered in the FAT area as shown in FIG. 22. By referencing the information managed in the FAT area of FIG. 22, a file stored in a folder can be learned. The date and time of production (update) of the file and the data size of the file are also learned.

For example, the thumbnail files are fully loaded with the corresponding thumbnail image data. FIG. 23 illustrates such a state with the thumbnail files fully loaded with the corresponding thumbnail image data. By repeating the process of FIGS. 11 and 12, the Exif files “yyy0001.jpg” through “yyy0100.jpg” are registered in the folder “100”.

The thumbnail file “0001.thm” of FIG. 23 corresponds to Exif file “yyy0001.jpg” through “yyy0100.jpg” (see the table of FIG. 13). As shown in FIG. 23, the date and time of production of the corresponding Exif file and the data size of the Exif file are described at the header. A maximum of 100 units of thumbnail image data is stored in the thumbnail file. In accordance with this embodiment, the size of one unit of thumbnail image data (size of one thumbnail slot) is 8 Kbytes, and the thumbnail image data of 100 Exif files is stored. The data size and the number of files are not limited to 8 Kbytes and 100 files, respectively. For example, the size of one unit of thumbnail image data may be 16 Kbytes, and thumbnail image data of 50 Exif files may be stored. The size of one unit of thumbnail image data may be 4 Kbytes, and thumbnail image data of 200 Exif files may be stored.

For example, the thumbnail image data corresponding to the Exif file “yyy0003.jpg” is read from the thumbnail file thus produced as shown in FIG. 23. This reading process is performed based on a product of 8 Kbytes and a value that is obtained by subtracting 1 from Exif file number, and a front position of the thumbnail file (front position of the thumbnail file managed in the FAT information). If at least one unit of thumbnail image data is registered in the thumbnail file, consecutive areas are reserved as thumbnail slots in a region where no thumbnail image data is registered. The thumbnail image data specified is thus quickly read.

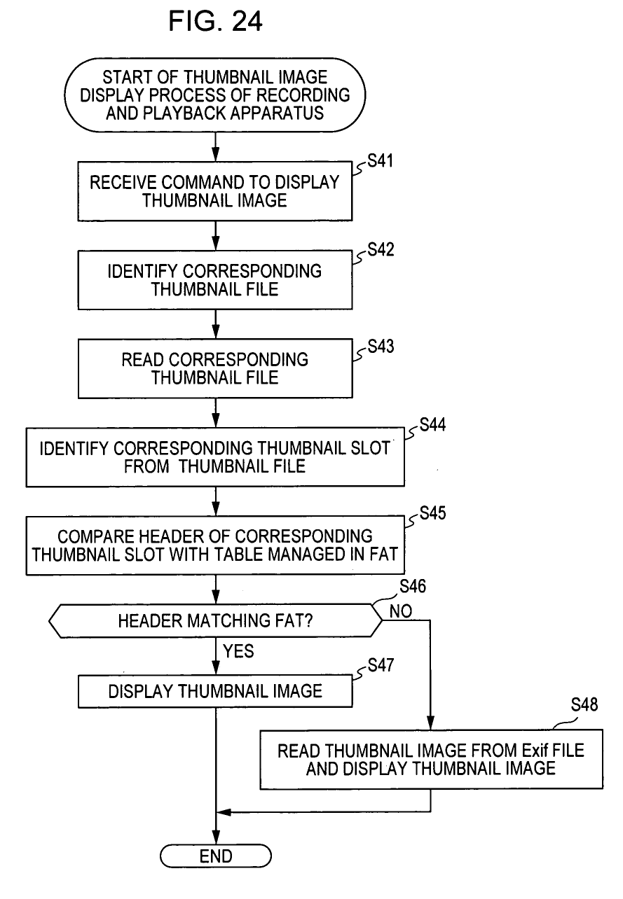

A thumbnail image display process of the recording and playback apparatus 1 of FIG. 3 is described below with reference to a flowchart of FIG. 24. The thumbnail image display process is started with an Exif file and a thumbnail file recorded on the magneto-optic disk 21 when the process of FIGS. 11 and 12 ends.

In step S41, the operation input unit 14 receives a user command to display a thumbnail image. For example, the operation input unit 14 receives a user command to display a thumbnail image corresponding to an Exif file “yyy0003.jpg” in the directory “root/DCIM/100/” of FIG. 18. The operation input unit 14 supplies a control signal responsive to the received command to the main controller 71. Upon receiving the command signal from the operation input unit 14, the main controller 71 commands the video processor 75 to display a thumbnail image. The video processor controller 81 in the video processor 75 receives the user command to display the thumbnail image. The thumbnail image corresponding to a single Exif file is displayed herein. Alternatively, a thumbnail image corresponding to a plurality of Exif files (for example, 6 Exif files) may be displayed. Such a case is described later.

In step S42, the thumbnail file identifying unit 88 in the video processor 75 identifies the thumbnail file corresponding to the thumbnail image specified by the user. If the thumbnail image corresponding to the Exif file “yyy0003.jpg” in the directory “root/DCIM/100/ is specified, the thumbnail file identifying unit 88 references the table of FIG. 13 storing in the table memory 83, and then determines that the thumbnail image is recorded on the same directory “0000.thm” in the directory “root/DCIM/100/” (in practice, the thumbnail file identifying unit 88 also learns the location of direction).

In step S43, the playback controller 80 under the control of the video processor controller 81 in the video processor 75 reads the corresponding thumbnail file. For example, since the thumbnail file “0001.thm” is identified in step S42, the video processor controller 81 commands the playback controller 80 to determine based on the FAT information the storage location of the thumbnail file on the magneto-optic disk 21, and then to read the file. The video processor controller 81 in the video processor 75 acquires the read thumbnail file (for example, the thumbnail file “0001.thm”).

In step S44, the thumbnail image validity determination unit 89 under the control of the video processor controller 81 identifies the thumbnail slot corresponding to the thumbnail file. For example, the thumbnail image validity determination unit 89 identifies the thumbnail slot corresponding to the read thumbnail file “0001.thm”, i.e., the thumbnail slot corresponding to the Exif file “yyy0003.jpg”. A plurality of thumbnail slots (for example, 100 thumbnail slots) are stored in the sequential order of small to large number in the thumbnail file. As shown in FIG. 20, the thumbnail image validity determination unit 89 acquires data of the thumbnail slot (thumbnail image data) at the location separated by 16 Kbytes={3 (number portion of the file base name of yyy0001.jpg)−1}×8 Kbytes from the front address of the thumbnail file “0001.thm”.

In step S45, the thumbnail image validity determination unit 89 compares the header of the acquired thumbnail slot with the table managed in the FAT. As shown in FIGS. 18 through 20, the thumbnail image validity determination unit 89 compares the header of the thumbnail image data of “yyy0003.jpg” of FIG. 20 (header of the thumbnail slot at the third position), namely, “1.5 MB”, and “Aug. 16, 2004” with data corresponding to “yyy0003.jpg” in the table managed in the FAT of FIG. 19, namely, “1.5 MB” and “Aug. 16, 2004”.

In step S46, the thumbnail image validity determination unit 89 determines whether the header matches the FAT. More specifically, the thumbnail image validity determination unit 89 determines whether the data size and the date and time of production in the header compared in step S45 match the data size and the date and time of production in the FAT. In the case of “yyy0003.jpg” of FIGS. 18 through 20, these units of data match each other, and processing proceeds to step S47.

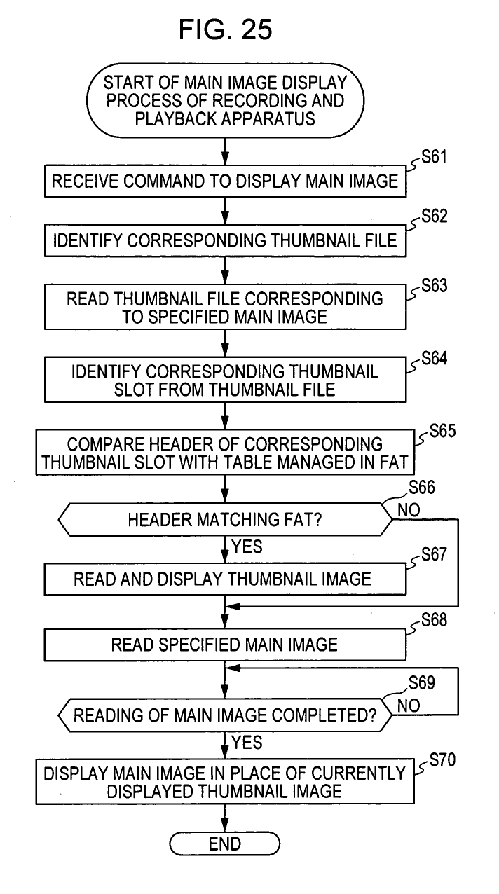

In accordance with the present embodiment, the thumbnail image validity determination unit 89 determines in step S46 whether the data size and the date and time of production (update) of the Exif file stored in the header respectively match the data size and the date and time of production (update) of the Exif file stored in the FAT area. The target of comparison can be only the date and time. If the data size of the Exif file stored in the header is zero, the thumbnail image validity determination unit 89 determines that no thumbnail image data is registered (no in step S46). If it is determined that the data size of the Exif file stored in the header is not zero, the thumbnail image validity determination unit 89 compares the date and time of production of the Exif file stored in the header with the date and time production of the Exif file stored in the FAT area for matching. This method is applicable to following processes (for example, a process of FIG. 25).

If it is determined in step S46 that the header matches the FAT, the display controller 90 under the control of the video processor controller 81 controls the displaying of the thumbnail image on the display 76. For example, the display controller 90 causes the display 76 to display the “thumbnail image data of yyy0003.jpg” stored in the third thumbnail slot of FIG. 20.

If it is determined in step S46 that the header fails to match the FAT, processing ends with step S47 skipped. More specifically, if a command to display the thumbnail image of a file not recorded in the video capturing process of FIGS. 11 and 12 is issued, the thumbnail file is basically not updated, and the header fails to match the FAT. If the header fails to match the FAT, the thumbnail image is not displayed even when the thumbnail image data is recorded in the slot corresponding to the thumbnail file.

If a command to display the thumbnail image is issued in the process of FIG. 24, the thumbnail image data contained in the thumbnail file rather than the thumbnail image data contained in the Exif file is displayed. The displaying of the thumbnail image is quickly displayed. This is because the reading of the thumbnail image data from the thumbnail file is faster than the reading of the thumbnail image data from the Exif file.

If the thumbnail file corresponding to the thumbnail image contains the thumbnail image data and if the information of the header of the thumbnail slot matches the information of the file recorded in the FAT area, the thumbnail image data is displayed. If one of the thumbnail file and the thumbnail image data is not present, the thumbnail image data is acquired from the corresponding Exif file and displayed.

In response to no answer in the determination of step S46 as shown in FIG. 24, the thumbnail image data is read from the Exif file. Instead of reading the thumbnail image data from the Exif file, a default screen (such as a blue color screen) may be displayed. The same is true in the following processes (such as the process of FIG. 25).

As shown in FIG. 24, one thumbnail image is displayed. Six reduced thumbnail images can be concurrently displayed on the display 76. If a user command to display six thumbnail images is issued, each of the six Exif files is read, and the thumbnail image data is successively acquired from the Exif files. Alternatively, the thumbnail file corresponding to the six Exif files is read, and the thumbnail image data corresponding to the six Exif files is read from the thumbnail file. This alternative method reduces the number of read processes to the magneto-optic disk 21, and the thumbnail image can be displayed more quickly. When a command to display the thumbnail image corresponding to the Exif files “yyy0001.jpg” through “yyy0001.jpg” is issued in the process of FIG. 18, it is sufficient to read a single thumbnail file “0001.thm”. The thumbnail image is displayed faster.

A main image display process of the recording and playback apparatus 1 of FIG. 3 is described below with reference to a flowchart of FIG. 25. The main image display process is started with the Exif file and the thumbnail file recorded after the process of FIGS. 11 and 12 ends.

In step S61, the operation input unit 14 receives a user command to display a main image. For example, the operation input unit 14 receives a user command to display a main image corresponding to an Exif file “yyy0003.jpg” in the directory “root/DCIM/100/” of FIG. 18. The operation input unit 14 supplies a control signal responsive to the received command to the main controller 71. Upon receiving the command signal from the operation input unit 14, the main controller 71 commands the video processor 75 to display a main image. The video processor controller 81 in the video processor 75 receives the user command to display the thumbnail image. The main image corresponds to the Exif file “yyy0003.jpg”. The issue of the command to display the Exif file “yyy0003.jpg” can be accepted as a command to display the main image.

In step S62, the thumbnail file identifying unit 88 in the video processor 75 identifies the thumbnail file corresponding to the main image specified by the user. If the Exif file “yyy0003.jpg” in the directory “root/DCIM/100/ is specified, the thumbnail file identifying unit 88 references the table of FIG. 13 stored in the table memory 83, and then determines that the thumbnail image is recorded on the same directory “0000.thm” (in the directory “root/DCIM/100/”). In practice, the thumbnail file identifying unit 88 also acknowledges the location of the directory.

In step S63, the playback controller 80 under the control of the video processor controller 81 in the video processor 75 reads the corresponding thumbnail file. For example, since the thumbnail file “0001.thm” is identified in step S42, the video processor controller 81 commands the playback controller 80 to determine based on the FAT information the storage location of the thumbnail file on the magneto-optic disk 21, and then to read the file. The video processor controller 81 in the video processor 75 acquires the read thumbnail file (for example, the thumbnail file “0001.thm”).

In step S64, the thumbnail image validity determination unit 89 under the control of the video processor controller 81 identifies the thumbnail slot corresponding to the specified main image (Exif file) from the thumbnail file. For example, the thumbnail image validity determination unit 89 identifies the third thumbnail slot corresponding to the specified Exif file (“yyy0003.jpg”) from the read thumbnail file “0001.thm”.

In step S65, the thumbnail image validity determination unit 89 compares the header of the acquired thumbnail slot with the table managed in the FAT. As shown in FIGS. 18 through 20, the thumbnail image validity determination unit 89 compares the header of the thumbnail image data of “yyy0003.jpg” of FIG. 20 (header of the thumbnail slot at the third position), namely, “1.5 MB”, and “Aug. 16, 2004” with data corresponding to “yyy0003.jpg” in the table managed in the FAT of FIG. 19, namely, “1.5 MB” and “Aug. 16, 2004”.

In step S66, the thumbnail image validity determination unit 89 determines whether the header matches the FAT. More specifically, the thumbnail image validity determination unit 89 determines whether the data size and the date and time of production in the header compared in step S65 match the data size and the date and time of production in the FAT. In the case of “yyy0003.jpg” of FIGS. 18 through 20, these units of data match each other, and processing proceeds to step S67. As previously discussed with reference to FIG. 24, if the data size of the header of the thumbnail slot is not zero, it may be determined if the data and time of the header matches the date and time stored in the FAT area.

If it is determined in step S66 that the header matches the FAT, the display controller 90 under the control of the video processor controller 81 controls the displaying of the thumbnail image on the display 76 in step S67. For example, the display controller 90 causes the display 76 to display the “thumbnail image data of yyy0003.jpg” stored in the third thumbnail slot of FIG. 20. For example, the display controller 90 controls the display 76 to display the thumbnail image in an expanded size to fit to the full screen size in response to the thumbnail image data.

In step S68, the playback controller 80 under the control of the video processor controller 81 reads the specified main image, namely, Exif file. More specifically, the playback controller 80 reads the Exif file “yyy0003.jpg” of FIG. 20 based on the information of the FAT area.

In step S69, the video processor controller 81 determines whether the playback controller 80 has completed the reading of the main image (Exif file). If it is determined that the reading has not been completed, the video processor controller 81 waits on standby until the completion of the reading.

If it is determined in step S69 that the reading of the main image has been completed, processing proceeds to step S70. The playback controller 80 causes the display 76 to display the read main image instead of the thumbnail image displayed on the display 76. More specifically, the display controller 9b causes the display 76 to display the image responsive to the main image data contained in the Exif file read by the playback controller 80 instead of the thumbnail image currently displayed on the display 76.

When the command to display the main image is issued in the process of FIG. 25, the thumbnail image contained in the thumbnail image is displayed until the reading of the Exif file containing the main image is completed. A fast responsive image (namely, the thumbnail image) is thus displayed. It takes time to read the Exif file. The user can view the thumbnail image recorded in the thumbnail file during waiting time (until the main image of the Exif file is displayed).

A plurality of units of thumbnail image data corresponding to a plurality of Exif files are together recorded as a thumbnail file. When the thumbnail images are displayed continuously, read time from the magneto-optic disk 21 is reduced.

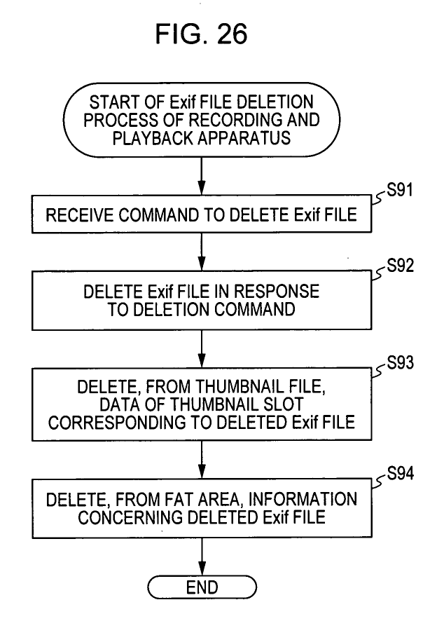

An Exif file deletion process of the recording and playback apparatus 1 of FIG. 3 is described below with reference to a flowchart of FIG. 26. The file deletion process is started when the user issues a command to delete a predetermined Exif file. For example, the file deletion process is started with one of the thumbnail image and the main image corresponding to the Exif file displayed on the display 76 when the user enters a deletion command to the operation input unit 14. The file deletion process is also started with the Exif file and the thumbnail file recorded on the magneto-optic disk 21.

In step S91, the operation input unit 14 receives an Exif file deletion command from the user. For example, the operation input unit 14 receives a deletion command to delete the Exif file “yyy0003.jpg” in the directory “root/DCIM/100” of FIG. 18. The operation input unit 14 supplies the main controller 71 with a control signal responsive to the received command. Upon receiving the control command from the operation input unit 14, the main controller 71 commands the video processor 75 to delete the thumbnail image. The video processor controller 81 in the video processor 75 receives the Exif file deletion command from the user.

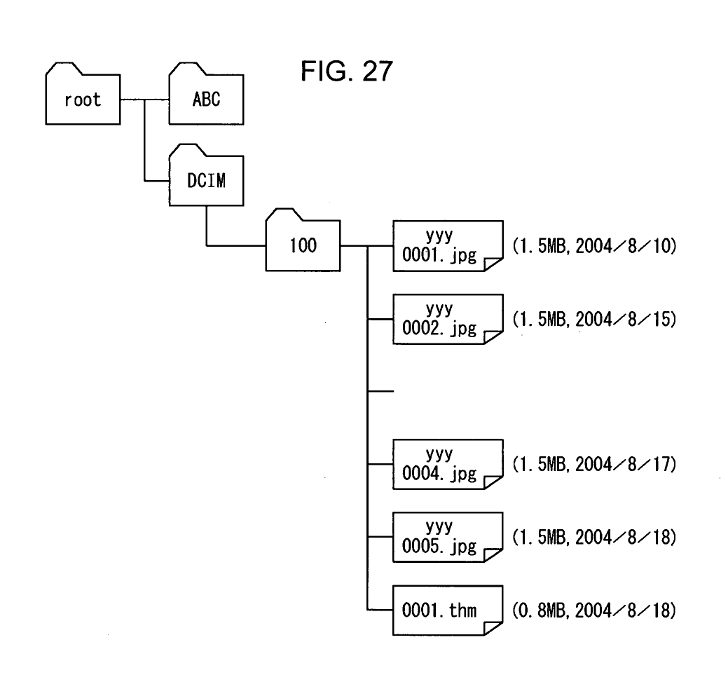

In step S92, the video processor controller 81 controls the record controller 79 in the recording and playback control block 77 to delete the Exif file in response to the deletion command. For example, the video processor controller 81 controls the record controller 79 to delete the Exif file “yyy0003.jpg” in the directory “root/DCIM/100”. As shown in FIG. 27, the Exif file “yyy0003.jpg” in the directory “root/DCIM/100” is thus deleted. FIG. 27 shows the directory “root/DCIM/100” of FIG. 18 without the Exif file “yyy0003.jpg”.

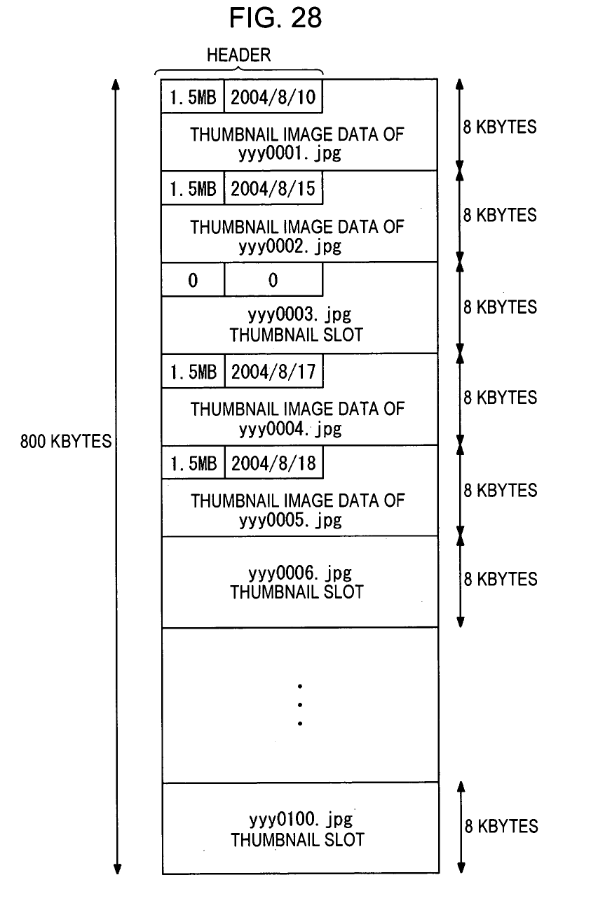

In step S93, the thumbnail file generator 86 under the control of the video processor controller 81 controls the record controller 79 in the recording and playback control block 77 to delete from the thumbnail file the thumbnail image data corresponding to the deleted Exif file. For example, the thumbnail file generator 86 controls the record controller 79 to delete the thumbnail image data corresponding to the deleted Exif file “yyy0003.jpg” in the directory “root/DCIM/100” from “0001.thm” in the directory “root/DCIM/100” as the corresponding thumbnail file. More specifically, the thumbnail file identifying unit 88 identifies the thumbnail file “0001.thm” of FIG. 20 corresponding to the deleted Exif file “yyy0003.jpg” in the directory “root/DCIM/100”, based on the table of FIG. 13 stored in the table memory 83. The thumbnail file generator 86 calculates the storage location of the thumbnail image data (namely, the location of the thumbnail slot of “yyy0003.jpg”) corresponding to the Exif file “yyy0003.jpg” in the identified thumbnail file “0001.thm” of FIG. 20. The thumbnail file generator 86 calculates 16 Kbytes (={(3−1)×8 Kbytes}. The thumbnail file generator 86 controls the record controller 79 to delete data recorded on the thumbnail slot yyy0003.jpg in response to the calculation results. The “thumbnail image data of yyy0003.jpg” of FIG. 20 is thus deleted. The third position of the thumbnail file “0001.thm” (separated by 16 Kbytes from the front address of the “0001.thm”) becomes the “yyy0003.jpg thumbnail slot”. The data at the header is all reset (all values at the header are set be zeroes as shown in FIG. 28). FIG. 28 illustrates the thumbnail file of FIG. 20 without the “thumbnail image data of yyy0003.jpg”. The third slot of FIG. 28 is at a state prior to the storage of thumbnail image data, namely, at a state at the third slot of FIG. 14.

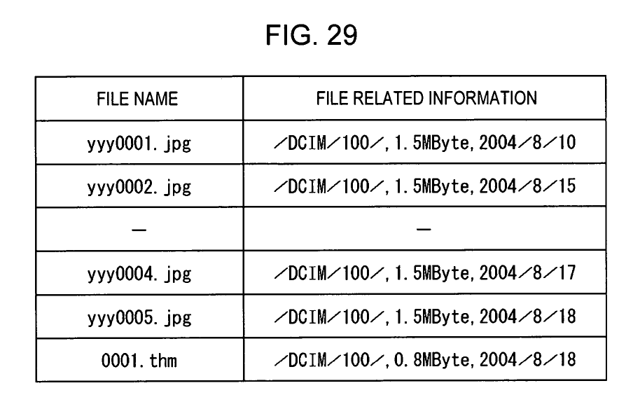

In step S94, the thumbnail file identifying unit 88 controls the record controller 79 in the recording and playback control block 77 to delete information relating to the deleted Exif file from the FAT area. In response, the record controller 79 deletes information corresponding to the Exif file “yyy0003.jpg” in the directory “root/DCIM/100” from the information managed by the FAT of FIG. 29. As shown in FIG. 29, the information “yyy0003.jpg” in the directory “root/DCIM/100” is thus deleted. FIG. 29 illustrates the directory “root/DCIM/100” of FIG. 19 without the information of the FAT area relating to the Exif file “yyy0003.jpg”. Processing ends subsequent to step S94.

If the command to delete the Exif file is issued in the recording and playback apparatus 1, the thumbnail image data is deleted from the thumbnail file storing the thumbnail image data. The thumbnail image data stored in the thumbnail file is correctly associated with the Exif file.

If the magneto-optic disk 21 is write-protected, the recording and deletion operation cannot be performed. The same is true in other operations.

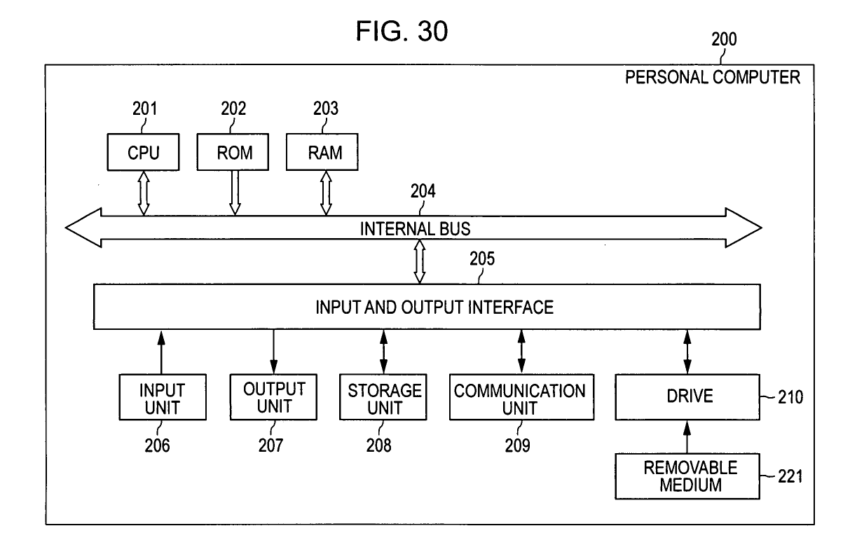

With reference to FIG. 29, the Exif file is deleted in the recording and playback apparatus 1. An external apparatus having no program to update the thumbnail file can delete an Exif file. The deletion process of the external apparatus is described below. The external apparatus is a personal computer 200 of FIG. 30, for example.

As shown in FIG. 30, a central processing unit (CPU) 201 performs a variety of processes in accordance with one of a computer program stored in a read-only memory (ROM) 202 and a computer program loaded to a random-access memory (RAM) 203 from a storage unit 208. The RAM 203 stores, as necessary, data required for the CPU 201 to perform a variety of processes.

The CPU 201, the ROM 202, and the RAM 203 are mutually interconnected to each other via an internal bus 204. The internal bus 204 also connects to an input and output interface 205.

The input and output interface 205 connects to an input unit 206 composed of a keyboard, a mouse, etc., an output unit 207 composed a display, such as a cathode-ray tube (CRT), or a liquid-crystal display (LCD), and a loudspeaker, a storage unit 208 such as a hard disk, and a communication unit 209 composed of a modem, a terminal adaptor, etc. The communication unit 209 performs a communication process via a variety of networks including a telephone line and a cable television (CATV).

A drive 210 is connected to the input and output interface 205 as necessary. A removable medium 221, such as one of a magnetic disk, an optical disk, a magneto-optic disk, and a semiconductor memory, is loaded to the drive 210. A computer program read from the removable medium 221 is installed onto the storage unit 208 as necessary.

The magneto-optic disk 21 of the present embodiment, loaded as the removable medium 221 onto the drive 210, is controlled for recording and playback.

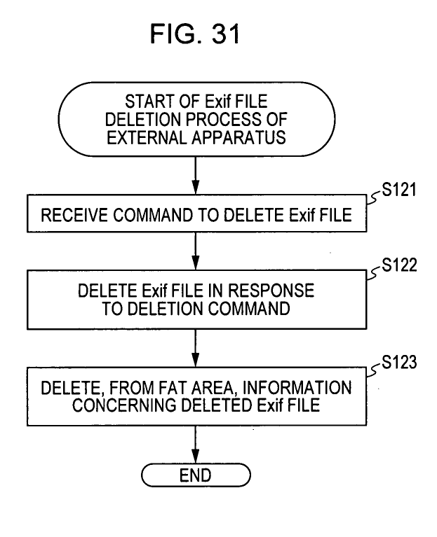

An Exif file deletion process of the external apparatus is described below with reference to a flowchart of FIG. 31. The external apparatus herein is the personal computer 200 of FIG. 30. The file deletion process is started with the Exif file and the thumbnail file recorded on the magneto-optic disk 21 (removable medium 221).

In step S121, the input unit 206 receives an Exif file deletion command from the user. For example, the input unit 206 receives a command to delete the Exif file “yyy0004.jpg” in the directory “root/DCIM/100” of FIG. 27. The input unit 206 supplies a control signal responsive to the received command to the CPU 201 via the input and output interface 205 and the internal bus 204.

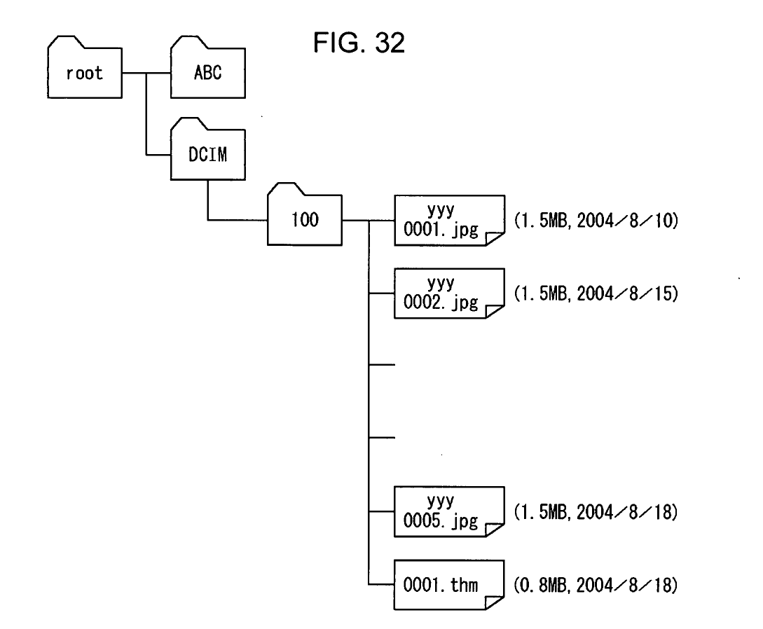

In step S122, the CPU 201 controls the drive 210 to delete the Exif file in response to the deletion command. For example, the CPU 201 controls the drive 210 via the internal bus 204 and the input and output interface 205 to delete the Exif file “yyy0004.jpg” in the directory “root/DCIM/100” of FIG. 27. The Exif file “yyy0004.jpg” in the directory “root/DCIM/100” is deleted as shown in FIG. 32. FIG. 32 shows the configuration of the directory “root/DCIM/100” of FIG. 27 without the Exif file “yyy0004.jpg”.

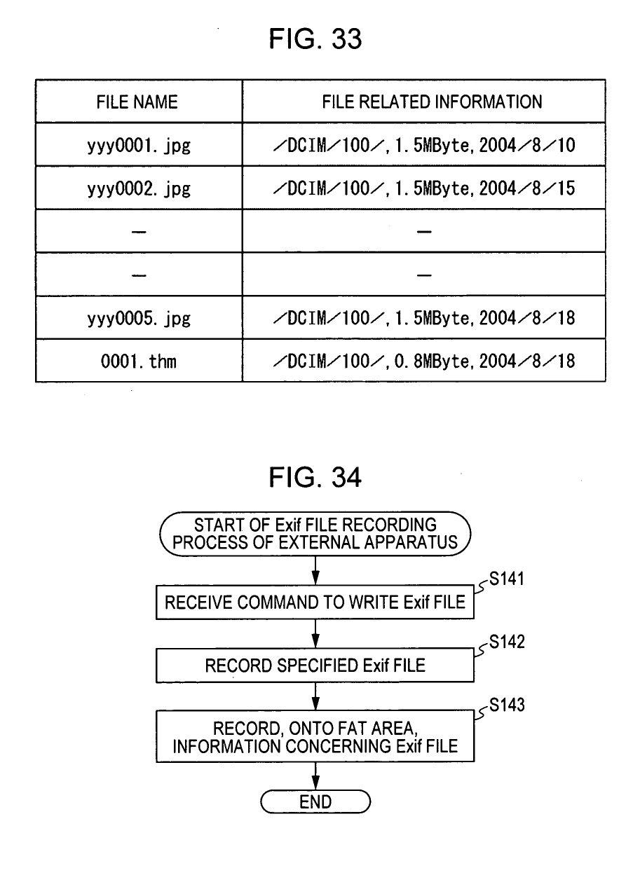

In step S123, the CPU 201 controls the drive 210 to delete information relating to the deleted Exif file from the FAT area. For example, the CPU 201 deletes the information of the FAT area corresponding to the Exif file “yyy0004.jpg” in the directory “root/DCIM/100”. As shown in FIG. 33, the information of the Exif file “yyy0004.jpg” in the directory “root/DCIM/100” is deleted. FIG. 33 thus illustrates the directory “root/DCIM/100” of FIG. 29 without the information of the FAT area corresponding to the Exif file “yyy0004.jpg”. Processing ends subsequent to step S123.

If the command to delete the Exif file is issued in the external apparatus (personal computer 200), the Exif file is deleted from the magneto-optic disk 21 and the information corresponding to the Exif file is deleted from the FAT area. The deletion process is different from the process of FIG. 26 in that the thumbnail image data in the thumbnail file is not deleted. More specifically, even if the external apparatus results in the states of FIGS. 32 and 33, the thumbnail file remains unchanged from FIG. 28.

When the command to delete the Exif file in the recording and playback apparatus 1, the process of FIG. 31 rather than the process of FIG. 26 may be performed. In other words, the Exif file and the information of the FAT area corresponding to the Exif file are deleted but the thumbnail image data stored in the thumbnail file corresponding to the Exif file is not deleted. Furthermore, when the command to delete the Exif file in the recording and playback apparatus 1, only the information of the FAT area corresponding to the Exif file may be deleted. If the information of the FAT area corresponding to the Exif file is deleted, the Exif file cannot be typically read.

An Exif file storage process of the external apparatus is described below with reference to a flowchart of FIG. 34. The external apparatus herein is the personal computer 200 of FIG. 30. The storage process is started with the Exif file and the thumbnail file recorded on the magneto-optic disk 21 (removable medium 221).

In step S141, the input unit 206 receives a write command to write a predetermined Exif file onto the magneto-optic disk 21 (as the removable medium 221) from the user. For example, the input unit 206 receives a write command to write the Exif file called “yyy0004.jpg” in the directory “root/DCIM/100” of FIG. 32. The Exif file “yyy0004.jpg” is different in data content from “yyy0004.jpg” of FIG. 27. The input unit 206 supplies a control signal responsive to the received command to the CPU 201 via the input and output interface 205 and the internal bus 204.

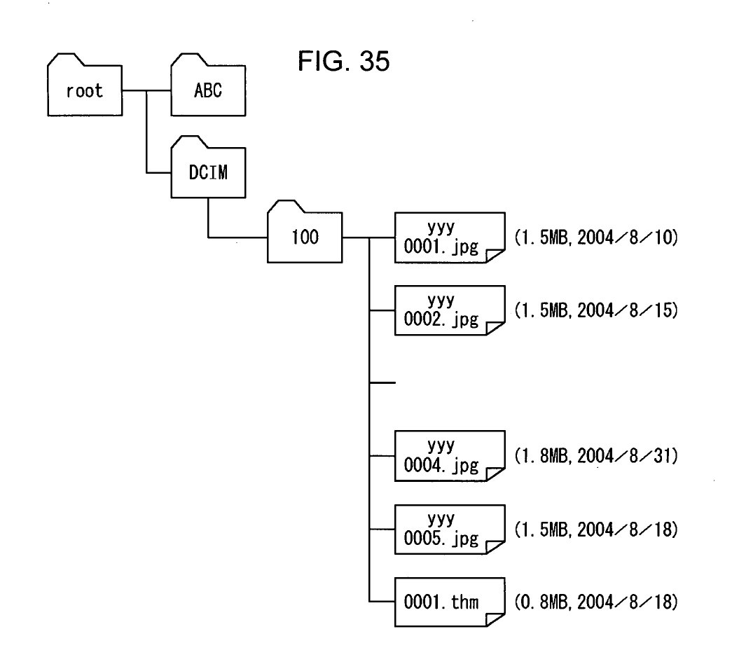

In step S142, the CPU 201 controls the drive 210 to record the specified Exif file. For example, the CPU 201 controls the drive 210 via the internal bus 204 and the input and output interface 205 to store the Exif file “yyy0004.jpg” responsive to the write command in the directory “root/DCIM/100” of FIG. 32. As shown in FIG. 35, the Exif file “yyy0004.jpg” is stored in the directory “root/DCIM/100”. FIG. 35 illustrates the directory “root/DCIM/100” of FIG. 32 with the Exif file “yyy0004.jpg” added thereto. The Exif file “yyy0004.jpg” has 1.8 MB as the data size of the file and Aug. 31, 2004 as the date and time of production of the file.

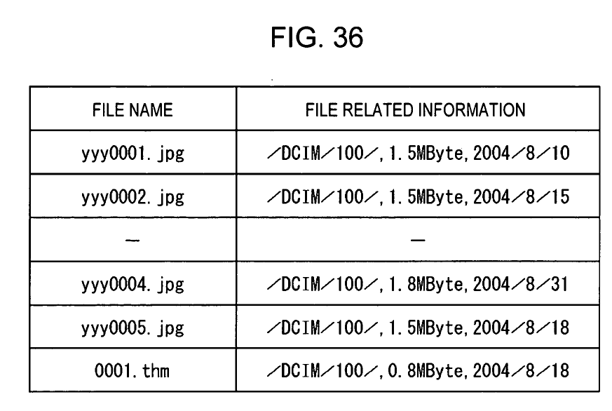

In step S143, the CPU 201 controls the drive 210 to record information of the recorded Exif file onto the FAT area. For example, the CPU 201 writes onto the FAT area the information of the Exif file “yyy0004.jpg” in the directory “root/DCIM/100”. As shown in FIG. 36, the information concerning the “yyy0001.jpg” in the directory “root/DCIM/100” is thus recorded on the FAT area. FIG. 36 illustrates the directory “root/DCIM/100” of FIG. 33 but with the information of the FAT area corresponding to the Exif file “yyy0004.jpg” recorded. The related information of the Exif file “yyy0004.jpg” contains on the FAT area “DCIM/100” as the storage location of the file, “1.8 MB” as the data size of the file, and “Aug. 31, 2004” as the date and time of production of the file. Processing ends subsequent to step S143.

If the command to record the Exif file in the external apparatus (personal computer 200) in the process of FIG. 34, the Exif file and the information in the FAT area are written onto the magneto-optic disk 21. The process of FIG. 34 is different from the process of FIGS. 11 and 12 in that the thumbnail image data of the thumbnail file is not recorded. Even if the external apparatus records the Exif file “yyy0004.jpg” as shown in FIGS. 35 and 36, the thumbnail file remains unchanged from the state of FIG. 28. More specifically, if the external apparatus deletes the Exif file “yyy0004.jpg” in the state of FIGS. 27, 28, and 29 in the process of FIG. 31, the magneto-optic disk 21 takes the state of FIGS. 32, 28, and 33. In other words, the thumbnail file of FIG. 28 remains unchanged. If the external apparatus records the Exif file “yyy0004.jpg” in the state of FIGS. 32, 28, and 33 in the process of FIG. 34, the magneto-optic disk 21 takes the state of FIGS. 35, 28, and 36. In other words, the thumbnail file is not updated.

In the state of FIGS. 27, 28, and 29, the Exif file “yyy0004.jpg” in the directory “root/DCIM/100” applies. The Exif file “yyy0004.jpg” recorded later in the process of FIG. 34 is the one recorded by the external apparatus, and fails to match the thumbnail image data of the yyy0004.jpg of the thumbnail file of FIG. 28.

The process of FIG. 24 is performed in the state of FIGS. 32, 28, and 33, for example. The header of the thumbnail slot corresponding to the Exif file “yyy0004.jpg” in the directory “root/DCIM/100” of FIG. 28 (with a data size of 1.5 MB and the date and time of production Aug. 17, 2004) is different in content from the information of Exif file “yyy0004.jpg” (no contented contained) managed in the FAT area of FIG. 33. For this reason, the “thumbnail image data of yyy0004.jpg” is not displayed from the thumbnail file. In other words, an erroneous operation that the “thumbnail image data of yyy0004.jpg” is displayed is avoided. Similarly, when the process of FIG. 25 is performed in the same state, the header fails to match the FAT. The displaying of an erroneous screen is thus avoided.

The process of FIG. 24 is performed in the state of FIGS. 35, 28, and 36, for example. The header of the thumbnail slot corresponding to the Exif file “yyy0004.jpg” in the directory “root/DCIM/100” of FIG. 28 (with a data size of 1.5 MB and the date and time of production Aug. 17, 2004) is different in content from the information of Exif file “yyy0004.jpg” (with a data size of 1.8 MB and the date and time of production Aug. 31, 2004) managed in the FAT area of FIG. 36. For this reason, the “thumbnail image data of yyy0004.jpg” is not displayed from the thumbnail file. In other words, an erroneous operation that the image based on the “thumbnail image data of yyy0004.jpg” is displayed is avoided. Similarly, when the process of FIG. 25 is performed in the same state, the header fails to match the FAT. The displaying of an erroneous screen is thus avoided.

The recording process of the Exif file has been discussed with reference to FIG. 34. The recording process is applied to files having other formats. For example, document files, and moving picture expert's group (MPEG) files can be recorded in the same manner as the process of FIG. 34.

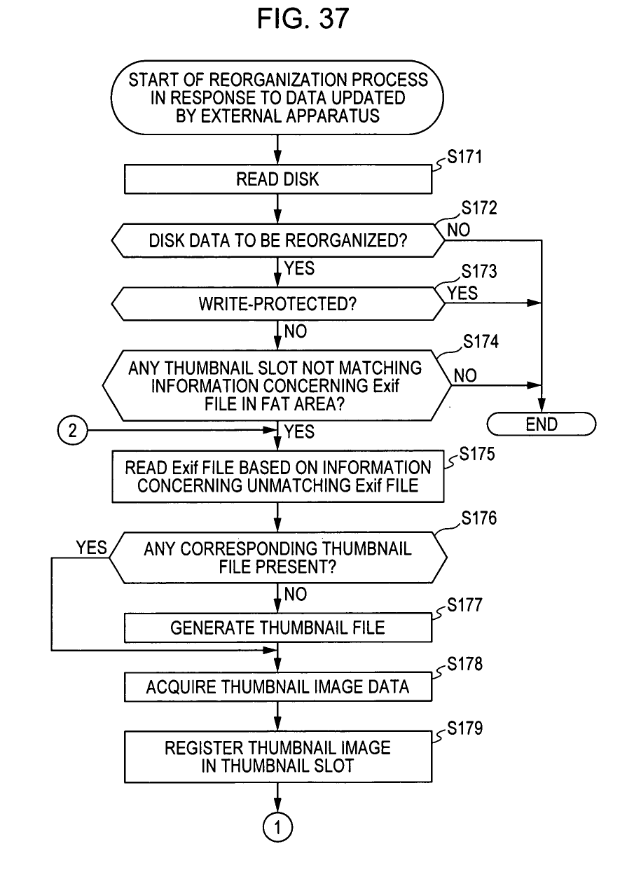

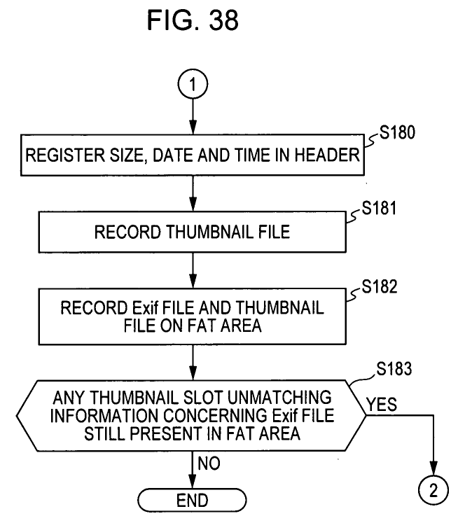

If data is updated by the external apparatus (subsequent to the process of FIGS. 31 and 34 performed onto the magneto-optic disk 21), the recording and playback apparatus 1 of FIG. 3 performs a reorganization process. The reorganization process is described below with reference to a flowchart of FIGS. 37 and 38. The reorganization process is performed when the magneto-optic disk 21 is loaded onto the recording and playback apparatus 1.

In step S171, the playback controller 80 in the recording and playback control block 77 reads data from the loaded magneto-optic disk 21.

In step S172, the video processor controller 81 in the video processor 75 determines whether to reorganize the magneto-optic disk 21. If one of a video capturing process and an audio process (including recording and playing back audio data) is performed, the video processor controller 81 determines that the magneto-optic disk 21 needs no reorganization, and ends the reorganization process. If the video capturing process or the like is not performed, the video processor controller 81 determines in step S172 that the magneto-optic disk 21 needs reorganizing to be ready for the video capturing process or the like, and proceeds to step S173.

In step S173, the playback controller 80 in the recording and playback control block 77 determines whether the magneto-optic disk 21 is write-protected. If it is determined that the magneto-optic disk 21 is write-protected, data cannot be written onto the magneto-optic disk 21, and processing ends. If it is determined in step S173 that the magneto-optic disk 21 is not write-protected, processing proceeds to step S174.

In step S174, the thumbnail file generator 86 determines, based on the data read by the playback controller 80, whether any thumbnail slot fails to match the information concerning the Exif file in the FAT area. More specifically, the thumbnail file generator 86 compares the information concerning the Exif file stored in the DCIM folder in the FAT area supplied from the playback controller 80 with the header of the thumbnail slot contained in the thumbnail file in order to determine whether any thumbnail slot (header) fails to match the information concerning the Exif file.

In the state of FIGS. 35, 28, and 36 (subsequent to the process of FIG. 34), the Exif files “yyy0001.jpg” through “yyy0005.jpg” and the thumbnail file “0001.thm” are recorded in the folder “100” under the DCIM folder in the FAT area of FIG. 36. The thumbnail file “0001.thm” is excluded from determination process because the information concerning the Exif file is a target of the determination. The “thumbnail image data of yyy0001.jpg”, the “thumbnail image data of yyy0002.jpg”, the “thumbnail image data of yyy0004.jpg”, and the “thumbnail image data of yyy0005.jpg” are recorded in the thumbnail file of FIG. 28, and the remaining area of the thumbnail file is left as empty slots. The thumbnail file generator 86 compares the Exif files “yyy0001.jpg” through “yyy0005.jpg” in the directory “DCIM/100” in the FAT area with the header of the thumbnail slot contained in the thumbnail file in the same directory in order to determine whether any unmatching thumbnail slot is present.

More specifically, the thumbnail file generator 86 compares the information concerning the Exif file “yyy0001.jpg” in the FAT area with the data size and the date and time of production of the Exif file contained in the header of the “0001.thm” thumbnail slot in the thumbnail file. Similarly, the Exif files “yyy0002.jpg”, “yyy0004.jpg”, and “yyy0005.jpg” are determined. In this case, the information of the FAT area of the Exif file “yyy0004.jpg” includes “DCIM/100”, “1.8 MB”, and “Aug. 31, 2004”, and the information of the header of the thumbnail image data includes “1.5 MB”, and “Aug. 17, 2004”. The thumbnail file fails to match. If an Exif file is recorded with a corresponding thumbnail slot empty, the thumbnail slot is determined as being unmatching.

If it is determined in step S174 that any thumbnail slot not matching the information concerning the Exif file in the FAT area is not present, no reorganization process is required (because the thumbnail file, the FAT area, and the Exif file are matching). Processing thus ends.

If it is determined in step S174 that a thumbnail slot not matching the information concerning the Exif file in the FAT area is present, processing proceeds to step S175. In step S175, the playback controller 80 under the control of the video processor controller 81 reads the Exif file stored in the FAT area determined being unmatching. For example, the playback controller 80 reads the Exif file “yyy0004.jpg” stored in the directory “/DCIM/100” of FIG. 35. If a plurality of thumbnail slots not matching the information concerning the Exif file in the FAT area are present, the playback controller 80 reads one of the plurality of unmatching Exif files.

In step S176, the thumbnail file identifying unit 88 under the control of the video processor controller 81 determines whether any thumbnail file corresponding to the Exif file read in step S175 is present. More specifically, the thumbnail file generator 86 determines, based on the table of FIG. 13 stored in the table memory 83, whether any thumbnail file corresponding to the Exif file read in step S175 is present. If the Exif file “yyy0004.jpg” in the directory “/DCIM/100” is read in step S175, the thumbnail file generator 86 determines with reference to FIG. 13 whether the thumbnail file “0001.thm” (corresponding to the thumbnail file herein) is present in the same directory, namely, “DCIM/100”. In the state of FIGS. 35, 28, and 36, the thumbnail file generator 86 determines that the corresponding thumbnail file (namely, “0001.thm”) is present.

If it is determined in step S176 that the corresponding thumbnail file is not present, processing proceeds to step S177. The thumbnail file generator 86 under the control of the 81 generates a thumbnail file. More specifically, the thumbnail file generator 86 generates a thumbnail file (for example, the thumbnail file “0001.thm”) corresponding to the Exif file read in step S175. If it is determined in step S176 that the corresponding thumbnail file is present, step S177 is skipped.

If it is determined in step S176 that the corresponding thumbnail file is present, or subsequent to step S177, processing proceeds to step S178. The thumbnail file generator 86 acquires thumbnail image data from the Exif file. More specifically, the thumbnail file generator 86 acquires the thumbnail image data contained in the Exif file read in step S175 (thumbnail data of FIG. 5 contained in APP1 of the Exif file of FIG. 4). For example, the thumbnail file generator 86 acquires the thumbnail image data from the Exif file “yyy0004.jpg”.

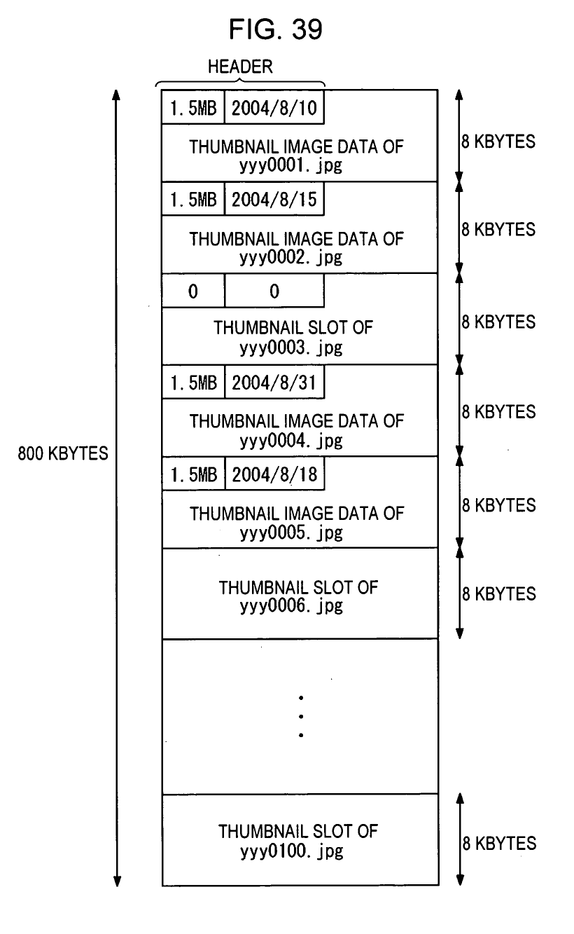

In step S179, the thumbnail file generator 86 registers the acquired thumbnail image (thumbnail image data) in the slot corresponding to the thumbnail file. For example, when the thumbnail image data is acquired from the Exif file “yyy0004.jpg”, the thumbnail file generator 86 registers the thumbnail image data as the “thumbnail image data of yyy0004.jpg” into the “yyy0004.jpg thumbnail slot” as a slot corresponding to the Exif file. In this way, the “thumbnail image data of yyy0004.jpg” of the thumbnail file “0001.thm” of FIG. 28 is registered (updated) as shown in FIG. 39. More specifically, the “thumbnail image data of yyy0004.jpg” of the thumbnail file of FIG. 28 is updated to the thumbnail image data acquired from the Exif file “yyy0004.jpg” of FIG. 35. The state of FIG. 39 thus results.

In step S180, the thumbnail file generator 86 registers the size and the date and time onto the header of the thumbnail slot. More specifically, the thumbnail file generator 86 registers the data size and the date and time of production of the Exif file of the “yyy0004.jpg” of FIG. 35 to the header of the “yyy0004.jpg thumbnail slot” of the thumbnail file. The data size of the Exif file is written on 0th IFD of FIG. 5, and the date and time of production of the Exif file are written on Exif IFD of FIG. 5. The thumbnail file generator 86 acquires and registers these units of information form the Exif file onto the header of the “yyy0004.jpg thumbnail slot” of the thumbnail file.

In step S181, the record controller 79 in the recording and playback control block 77 under the control of the video processor controller 81 causes the magneto-optic disk 21 to record the thumbnail file. The thumbnail file is stored at the same location as the folder of the corresponding Exif file, namely, in the directory “root/DCIM/100”. Since the thumbnail file having the same name as the thumbnail file “0001.thm” is already recorded, the record controller 79 overwrites (updates) the thumbnail file.

With this process performed, the “yyy0004.jpg” (Exif file) in the directory “root/DCIM/100” matches “0001.thm” (thumbnail file) on the magneto-optic disk 21. In other words, the data size and the date and time of production of the Exif file “yyy0004.jpg” match the data size and the date and time of the Exif file stored in the header of the fourth slot in the thumbnail file “0001.thm”.

In step S182, the FAT information processor 87 controls the record controller 79 in the recording and playback control block 77 to record (update) information relating to the thumbnail file in the FAT area on the magneto-optic disk 21. The recording of the information relating to the thumbnail file is intended to update the FAT area corresponding to the recording of the Exif file in step S181. The record controller 79 records (updates) the information concerning the thumbnail file onto the FAT area on the magneto-optic disk 21.

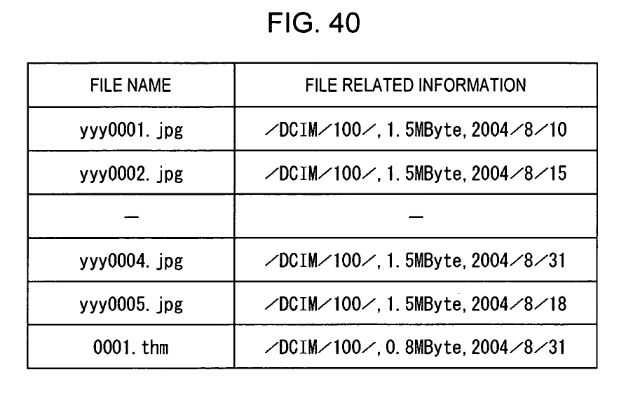

The information relating to the thumbnail file “0001.thm” on the FAT area of FIG. 36 is updated as shown in FIG. 40. More specifically, the date and time of update of the thumbnail file “0001.thm” of FIG. 36 is updated to “Aug. 31, 2004” (the current date herein is Aug. 31, 2004).

Through the above-referenced process, the state of FIGS. 35, 28, and 36 is updated to the state of FIGS. 35, 39, and 40. The information concerning the Exif file read in step S175 is updated. The thumbnail image data corresponding to the Exif file read in step S175 is registered (updated) in the thumbnail file.

Processing proceeds to step S183 subsequent to step S182. Based on the date read by the playback controller 80, the thumbnail file generator 86 determines whether any thumbnail file fails to match the information relating to the Exif file on the FAT area. This process step is identical to the process step in step S174. If the comparison of the information relating to the Exif file stored in the DCIM folder on the FAT area with the thumbnail slot contained in the thumbnail file determines that thumbnail image data not matching is still present, processing returns to step S175 to repeat step S175 and subsequent steps. The thumbnail file is updated based on a next Exif file determined as being unmatching, while the information of the FAT area is updated.

If it is determined in step S183 that thumbnail image data not matching the information relating to the Exif file on the FAT area is no longer present, processing ends.

The recording and playback apparatus 1 performs the reorganization process through the process of FIGS. 37 and 38 even if the external apparatus such as the personal computer records the Exif file on the magneto-optic disk 21. The thumbnail image data corresponding to a newly added Exif file can be added to the thumbnail file. The thumbnail image data of such a newly added Exif file is displayed at a high speed.

Even when the external apparatus records the Exif file on the magneto-optic disk 21, the date and time of production of the Exif file recorded on the header of the thumbnail image data (thumbnail slot) corresponding to the thumbnail file is likely to be different from the date and time of recording (production) of the Exif file managed in the FAT area. In this case, erroneous displaying of the thumbnail image is thus prevented.

In the state of FIGS. 32, 28, and 33, the thumbnail image data is stored in the fourth slot of the thumbnail file. As shown in FIG. 32 and 33, the Exif file “yyy0004.jpg” is not stored. The fourth thumbnail image data (thumbnail image data of yyy0001.jpg) in the thumbnail file is skipped in the reading operation. More specifically, playback is performed based on the information of the FAT area, and the information of the header of the thumbnail image data. Even if the video data is registered in the thumbnail file, invalid thumbnail image data is not displayed.

Even if the data stored in the thumbnail slot fails to match the Exif file, the matching process is performed. The process of FIGS. 37 and 38 is performed as necessary, and is not a requirement.

The thumbnail image data contained in each of at least one Exif file is stored on the magneto-optic disk 21 as a single thumbnail file. Images corresponding to the thumbnail image data are displayed at a high speed.

If the Exif file is updated but with the thumbnail file not updated, in other words, if the thumbnail image data stored in the thumbnail file fails to match the Exif file, the image based on the thumbnail image data incorrectly stored in the thumbnail file is not displayed. The matching thumbnail image is thus reliably displayed.

A list of thumbnail images is displayed by reading the thumbnail image data from one thumbnail file rather than reading the thumbnail image data from each Exif file. The list of thumbnail images is thus fast displayed.

The file name of the thumbnail file is uniquely determined based on the file name of the Exif file. The location of the corresponding thumbnail image data within the thumbnail file is uniquely determined. Cache management is thus easily performed.

In the above discussion, the recording and playback apparatus 1 employs the magneto-optic disk 21. The present invention is applicable when data is recorded on other recording media. The recording media include an optical disk, a magnetic disk, a magnetic tape, a memory card®, etc.

In the above-referenced embodiments, the extension of the thumbnail file is “thm”. The present invention is not limited to the extension “thm”.

The recording and playback apparatus 1 can be a compact mobile apparatus. In known compact mobile apparatuses, a disk medium as a recording medium is used, and a plurality of thumbnail images are successively displayed. In such a known apparatus, thumbnail image data is read from each Exif file, and repeated movement of threads increases power consumption although power saving feature is a demand in such a compact mobile apparatus. In accordance with embodiments of the present invention, the number of movements of threads is reduced, and power consumption is lowered.

In digital cameras where access speed to a recording medium (magneto-optic disk 21) is low, thumbnail images can be displayed at a high speed by collecting the thumbnail images individually contained in image files (Exif files) into a single thumbnail file in accordance with embodiments of the present invention. When a plurality of thumbnail images (for example, six thumbnail images) are concurrently displayed on a display of the digital camera, or when thumbnail images are consecutively displayed, it is sufficient to read the thumbnail file. The thumbnail images are fast displayed.

An apparatus records and plays back images on a disk as a recording medium. To display one of a list of still images and a full-screen image, Exif files need to be read from mutually spaced locations on the disk each time a single image is displayed. It takes time to read the Exif file from the disk. As a result, time from the inputting of a user operational input command to the displaying of the image on a display takes time. In accordance with embodiments of the present invention, individual units of thumbnail image data stored in a plurality of Exif files are acquired (copied) to produce a single file (thumbnail file). In other words, a thumbnail file, which is a collection of thumbnail image data, is produced. Without the need to access a real image file typically large in file size, accessing to the thumbnail file is performed. The thumbnail image is displayed at a high speed.

The size of the thumbnail file is relatively smaller than the overall data size of a plurality of Exif files. For example, the size of the thumbnail file is 0.8 Mbytes and a single Exif file is 1.5 Mbytes. The reading of the thumbnail image data is performed fast in comparison with the accessing to the plurality of Exif files. Since the size of the thumbnail file is significantly smaller than the overall size of the plurality of Exif files, the thumbnail file can be easily recorded in consecutive areas. A portable device having a low-capacity memory can cache the thumbnail file.

Since the file structure of the thumbnail file is based on a number corresponding to the name of the Exif file, cache management is easily performed. The relationship between the thumbnail file and the Exif file is listed in a table (such as the table of FIG. 13). Since the thumbnail file is produced based on the table, the thumbnail image data is easily read from the thumbnail file.

Since a single thumbnail file is partitioned in small segments with 100 Exif files, no space is wasted on the disk. The number of Exif files corresponding to a single thumbnail file is not limited to 100 files.

When the external apparatus performs processes (editing, overwriting, new production, deletion, etc) on the Exif file, data of the FAT area is stored on the header of each slot of the thumbnail file (thumbnail image data). An unmatch, if taking place between the Exif file and the thumbnail file, can be detected.

In accordance with embodiments of the present invention, the size of the Exif file and the date and time of production of the Exif file are stored onto the header. The present invention is not limited to this method. Any data can be used as long as the data accurately associates the Exif file with the thumbnail image data.

In accordance with embodiments of the present invention, data of the thumbnail image is copied from the Exif file to produce the thumbnail file. Alternatively, data related to an image file contained in the image file is copied from the image file, and related data of a plurality of image files can be generated. The present invention is not limited to the image file. The present invention is applicable to a file as long as the file contains information related to the image file.

The above-references series of steps can be performed by hardware or software. If the series of steps is performed by software, a program forming the software is installed from a recording medium or via a network onto a computer incorporated into a hardware structure or to a general-purpose computer, for example.

As shown in FIG. 30, the recording media include package media including the removable medium 221 having the program thereon and distributed to user separate from a computer to supply the user with the program. The recording media also include the ROM 202, and the hard disk including the storage unit 208, each having the program recorded thereon and supplied to the user in the apparatus.

The process steps discussed in this specification are sequentially performed in the time sequence order as stated. Alternatively, the steps may be performed in parallel or separately.

It should be understood by those skilled in the art that various modifications, combinations, sub-combinations and alterations may occur depending on design requirements and other factors insofar as they are within the scope of the appended claims or the equivalents thereof.

What is claimed is:

1. A recording and playback apparatus for recording data onto a disk-like recording medium, the recording and playback apparatus comprising:
means for acquiring video data and video related data related to the video data;
means for generating a related data file based on at least one unit of acquired video related data;
means for generating management information that manages a recording location of the generated related data file recorded on the disk-like recording medium; and
means for recording the generated related data file and the management information onto the disk-like recording medium.

2. The recording and playback apparatus according to claim 1, further comprising means for playing back, from the disk-like recording medium, a video data file containing the video data and the video related data, wherein the acquisition means acquires, from the playback video data file, the video data and the video related data.

3. The recording and playback apparatus according to claim 1, further comprising means for capturing the video data of an image; and
means for generating the video related data from the captured video data.

4. The recording and playback apparatus according to claim 3, further comprising means for generating the video data file based on the captured video data and the generated video related data.

5. The recording and playback apparatus according to claim 4, wherein the video data file generated by the video data file generating means is recorded as a file different from the video related data file onto the disk-like recording medium.

6. The recording and playback apparatus according to claim 2, wherein the video data file comprises an exchangeable image file.

7. The recording and playback apparatus according to claim 1, wherein the video related data comprises a thumbnail image containing the video data in a compressed form and having a predetermined data size.

8. The recording and playback apparatus according to claim 1, wherein the video related data contained in the video related data file is edited to a predetermined size.

9. The recording and playback apparatus according to claim 8, wherein the video related data of the predetermined size is stored in the video relate data file with the data size of the video data and the date of production of the video data attached thereto.

10. The recording and playback apparatus according to claim 9, wherein when a video file is deleted, the video data size of the video related data related to the deleted video file is modified to a predetermined value.

11. The recording and playback apparatus according to claim 1, wherein the video files and the related data files are recorded on the disk-like recording medium in a manner such that the video files are managed in the same management area by a predetermined number of files, and that the video related data files are managed in the same area as the video file related thereto.

12. A playback apparatus for playing back a video data from a disk-like medium storing a video file containing the video data and video related data related to the video data, the playback apparatus comprising:
means for playing back data from the recording medium;
means for extracting specified video related data from a related data file that is played back by the playback means that records at least one unit of video related data;
means for outputting the video data to a display displaying an image;
means for inputting an operational command to display the image; and
means for controlling the playback means to play back the related data file containing at least one unit of related data related to the image responsive to the command and to extract the video related data related to the video data from the playback related data file to display the extracted video related data on the display if the command to display the image is input by the operation input means.

13. A recording and playback method of recording data onto a disk-like recording medium and playing back data from the disk-like recording medium, the method comprising steps of:
acquiring video data and video related data related to the video data;
generating a related data file based on at least one unit of acquired video related data;
recording the generated related data file as data different from the video data onto the disk-like recording medium;
and recording, on the disk-like recording medium,
management information that manages the video data and the related data file containing the video related data.

14. The recording and playback method according to claim 13, further comprising steps of:
generating a video file containing the video data and the video related data; and
recording the generated video file onto the disk-like recording medium.

15. The recording and playback method according to claim 13, wherein the video related data comprises an exchangeable image file.

16. The recording and playback method according to claim 13, further comprising steps of: in response to the detection of a command to play back the video data,
playing back the related data file containing the video related data related to the video data responsive to the command; and
outputting, for displaying, the video related data contained in the playback related data file.
